(19) United States
(12) Patent Application Publication
(10) Pub. No.: US 2026/0001366 A1
(43) Pub. Date: Jan. 1, 2026

(54) IMAGE FORMING METHOD AND IMAGE FORMING APPARATUS

(71) Applicants: Hiroshi Gotou, Kanagawa (JP); Yuta Nakamura, Tokyo (JP); Shunsuke Horie, Kanagawa (JP)

(72) Inventors: Hiroshi Gotou, Kanagawa (JP); Yuta Nakamura, Tokyo (JP); Shunsuke Horie, Kanagawa (JP)

(73) Assignee: Ricoh Company, Ltd., Tokyo (JP)

(21) Appl. No.: 19/247,803

(22) Filed: Jun. 24, 2025

(30) Foreign Application Priority Data
Jun. 28, 2024 (JP) 2024-105592

(51) Int. Cl. B41M 5/025; B41J 2/005; B41J 2/01; B41J 11/00; B41M 5/00; B41M 7/00; C09D 11/02; C09D 11/38; C09D 11/54

(52) U.S. Cl. CPC B41M 5/0256; B41J 2/0057; B41J 11/0024; B41M 5/0017; B41M 7/009; C09D 11/02; C09D 11/38; C09D 11/54; B41J 2002/012

(57) ABSTRACT

An image forming method includes applying a pretreatment fluid to an intermediate transfer body, applying an aqueous ink to the pretreatment fluid on the intermediate transfer body, drying the pretreatment fluid and the aqueous ink to form an intermediate image, and thermally-transferring the intermediate image to a recording medium, wherein the following conditions (1) to (4) are satisfied:
(1) the intermediate transfer body has a surface with a Shore A Hardness of at most 80;
(2) the surface and the pretreatment fluid have a contact angle of at most 40 degrees at 1.5 seconds after contact;
(3) the aqueous ink and the surface of the intermediate transfer body have a contact angle of at most 40 degrees at 1.5 seconds after contact; and
(4) the pretreatment fluid and the aqueous ink have a surface tension of at most 22 mN/m at a bubble life time of 1,500 msec.

### CROSS-REFERENCE TO RELATED APPLICATIONS

This patent application is based on and claims priority pursuant to 35 U.S.C. § 119 to Japanese Patent Application No. 2024-105592, filed on Jun. 28, 2024, in the Japan Patent Office, the entire disclosure of which is hereby incorporated by reference herein.

### BACKGROUND

### Technical Field

The present disclosure relates to an image forming method, an ink set, and an image forming apparatus.

### Description of the Related Art

Aqueous ink is widely used as ink for inkjet recording methods. As a typical technique using aqueous ink, there is a so-called transfer-type image recording method in which an ink image, serving as an intermediate image, is formed on a transfer medium and then transferred to a recording medium to record an image.

### SUMMARY

According to embodiments of the present disclosure, an image forming method includes applying a pretreatment fluid to an intermediate transfer body, applying an aqueous ink to the pretreatment fluid on the intermediate transfer body, drying the pretreatment fluid and the aqueous ink to form an intermediate image, and thermally-transferring the intermediate image to a recording medium, wherein the following conditions (1) to (4) are satisfied:
(1) the intermediate transfer body has a surface with a Shore A Hardness of at most 80;
(2) the surface of the intermediate transfer body and the pretreatment fluid have a contact angle of at most 40 degrees at 1.5 seconds after the pretreatment fluid is applied onto the surface of the intermediate transfer body;
(3) the aqueous ink and the surface of the intermediate transfer body have a contact angle of at most 40 degrees at 1.5 seconds after the aqueous ink is applied onto the surface of the intermediate transfer body; and
(4) the pretreatment fluid and the aqueous ink have a surface tension of at most 22 mN/m at a bubble life time of 1,500 msec.

As another aspect of embodiments of the present disclosure, an image forming apparatus includes an intermediate transfer body, a pretreatment fluid applying device to apply a pretreatment fluid to the intermediate transfer body, an aqueous ink applying device to apply an aqueous ink onto the pretreatment fluid on the intermediate transfer body, a drying device to dry the pretreatment fluid and the aqueous ink to form an intermediate image, and a thermally-transferring device to thermally-transfer the intermediate image to a recording medium, wherein the following conditions (1) to (4) are satisfied:
(1) the intermediate transfer body has a surface with a Shore A Hardness of at most 80;
(2 the surface of the intermediate transfer body and the pretreatment fluid have a contact angle of at most 40 degrees at 1.5 seconds after the pretreatment fluid is applied onto the surface of the intermediate transfer body;
(3) the surface with a Shore A Hardness of at most 80 and the aqueous ink have a contact angle of at most 40 degrees at 1.5 seconds after the aqueous ink is applied onto the surface of the intermediate transfer body; and
(4) the pretreatment fluid and the aqueous ink have a surface tension of at most 22 mN/m at a bubble life time of 1,500 msec.

### BRIEF DESCRIPTION OF THE SEVERAL VIEWS OF THE DRAWINGS

A more complete appreciation of the disclosure and many of the attendant advantages and features thereof can be readily obtained and understood from the following detailed description with reference to the accompanying drawings, wherein:

FIG. 1 is a schematic diagram illustrating an image forming apparatus; and

FIG. 2 is a schematic diagram illustrating an example of an image chart printed with an image forming apparatus.

The accompanying drawings are intended to depict example embodiments of the present invention and should not be interpreted to limit the scope thereof. The accompanying drawings are not to be considered as drawn to scale unless explicitly noted. Also, identical or similar reference numerals designate identical or similar components throughout the several views.

### DESCRIPTION OF THE EMBODIMENTS

The terminology used herein is for the purpose of describing particular embodiments only and is not intended to be limiting of the present invention. As used herein, the singular forms “a,” “an,” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Embodiments of the present invention are described in detail below with reference to accompanying drawings. In describing embodiments illustrated in the drawings, specific terminology is employed for the sake of clarity. However, the disclosure of this patent specification is not intended to be limited to the specific terminology so selected, and it is to be understood that each specific element includes all technical equivalents that have a similar function, operate in a similar manner, and achieve a similar result.

For the sake of simplicity, the same reference number will be given to identical constituent elements such as parts and materials having the same functions and redundant descriptions thereof omitted unless otherwise stated.

According to the present disclosure, an image forming method and an image forming apparatus are provided which are capable of forming, on a recording medium, an image that exhibits excellent transferability of an intermediate image from an intermediate transfer body, superior transfer density and text sharpness, and further, excellent anti-beading in solid image areas.

The image forming apparatus and the image forming method of the present disclosure are described with reference to the accompanying drawings. It is to be noted that the following embodiments are not limiting the present disclosure and any deletion, addition, modification, change, etc. can be made within a scope in which man in the art can conceive including other embodiments, and any of which is included within the scope of the present disclosure as long as the effect and feature of the present disclosure are demonstrated.

### Image Forming Method and Image Forming Apparatus

The image forming method includes applying a pretreatment fluid to an intermediate transfer body, applying an aqueous ink to the pretreatment fluid on the intermediate transfer body, drying the pretreatment fluid and the aqueous ink to form an intermediate image, and thermally-transferring the intermediate image to a recording medium, wherein the following conditions (1) to (4) are satisfied:
(1) the surface of the intermediate transfer body has a Shore A Hardness of at moat 80;
(2) the pretreatment fluid and the surface of the intermediate transfer body has a contact angle of at most 40 degrees at 1.5 seconds after contact;
(3) the aqueous ink and the surface of the intermediate transfer body has a contact angle of at most 40 degrees at 1.5 seconds after contact; and
(4) the pretreatment fluid and the aqueous ink have a surface tension of at most 22 mN/m at a bubble life time of 1,500 msec.

The pretreatment fluid has a function of wetting the intermediate transfer body and contains a reacting agent that reacts with the aqueous ink.

The image forming apparatus of the present disclosure includes an intermediate transfer body, a pretreatment fluid applying device to apply a pretreatment fluid to an intermediate transfer body; an aqueous ink applying device to apply an aqueous ink onto pretreatment fluid on the intermediate transfer body; a drying device to dry the pretreatment fluid and the aqueous ink to form an intermediate image, and a thermally-transferring device to thermally-transfer the intermediate image to a recording medium.

The pretreatment fluid has a function of wetting the intermediate transfer body and contains a reacting agent that reacts with the aqueous ink.

To transfer an intermediate image formed with aqueous ink onto a recording medium, the intermediate transfer body and the recording medium are brought into contact and heated. This heating softens the intermediate image, allowing it to be transferred to the recording medium. However, in such transfer processes, factors such as the type of resin contained in the aqueous ink and the surface energy of the intermediate transfer body may prevent the intermediate image from being transferred to the recording medium. Even if transfer does occur, there may be untransferred areas (voids) in portions of the image formed on the recording medium, or fine text may be difficult to recognize due to poor sharpness.

The inventors of the present invention have made an intensive research and thus made the present invention. According to the present disclosure, an image can be formed on a recording medium and the image exhibits excellent transferability of an intermediate image from an intermediate transfer body, superior transfer density and character sharpness, and further, excellent anti-beading in solid image areas.

The image forming method and the image forming apparatus of the present disclosure are described next in detail.

The intermediate transfer body may also be referred to as an intermediate transfer substrate or a transfer medium. The image forming apparatus may also be referred to as a forming apparatus, and the image forming method may also be referred to as a forming method.

The pretreatment fluid mainly functions to increase the viscosity of the pigment and resin particles contained in the aqueous ink, and to wet the intermediate transfer substrate with the aqueous ink. The aqueous ink may simply be referred to as “ink.”

The recording medium onto which the intermediate image has been transferred may also be referred to as a recorded product or a printed material.

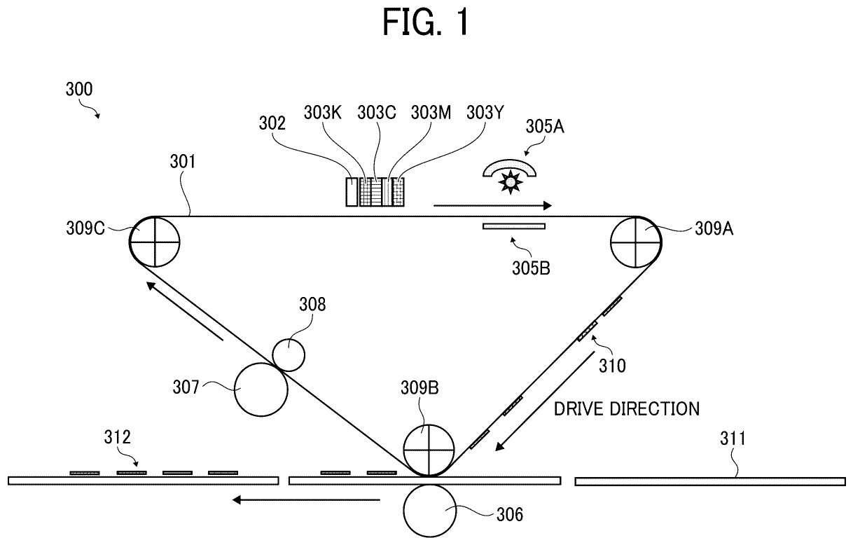

FIG. 1 is a schematic diagram illustrating an example of the image forming apparatus of the present disclosure. An image forming apparatus 300 illustrated in FIG. 1 produces a recorded product by transferring an intermediate image 310 onto a recording medium 311 via an intermediate transfer body 301. Such an image forming apparatus may be referred to as a transfer-type image forming apparatus.

The image forming apparatus 300 includes a pretreatment fluid discharging device 302, an ink discharging device 303, the intermediate transfer body 301, a drying device 305A, a drying device 305B, a heat roller 306, and a cleaning roller 307.

The intermediate transfer body 301 is supported by a drive roller 309A and 309C and a platen roller 309B, which serve as support members, and is conveyed in the direction indicated by the black arrows in FIG. 1. The transport of the intermediate transfer body 301 may also be referred to as movement or rotation. In this example, the intermediate transfer body 301 is a belt-like member and may be referred to as an intermediate transfer belt.

The pretreatment fluid discharging device 302 is an example of a pretreatment fluid applying unit and discharges a pretreatment fluid onto the intermediate transfer body 301. The pretreatment fluid mainly contains a component that promotes wetting of the intermediate transfer body 301 and a reactive agent that reacts with the aqueous ink.

To form a high quality image on the intermediate transfer body 301, the pretreatment fluid must be capable of wetting the surface of the intermediate transfer body 301, especially when the surface is made of silicone rubber or fluorine rubber. Therefore, it is necessary to lower the surface tension of the pretreatment fluid. It was found that image formation becomes difficult unless the dynamic surface tension of the pretreatment fluid at a bubble life time of 1500 msec is no more than 22 mN/m.

A particularly preferable range is 18 mN/m to 22 mN/m, and more preferably 18 mN/m to 21 mN/m.

In addition, simply reducing the dynamic surface tension of the aqueous ink to no more than 22 mN/m at a bubble life time of 1500 msec does not suffice to form a high-quality image on the intermediate transfer body 301.

This high-quality image can be formed if both the pretreatment fluid and the aqueous ink have a dynamic surface tension of at most 22 mN/m.

The ink discharging device 303 is an example of an ink applying unit and discharges the aqueous ink. In this example, the ink applying unit as a device for applying an aqueous ink includes, for instance, discharging devices 303K, 303C, 303M, and 303Y. If these discharging devices are referred to collectively without distinguishing among them, they may simply be referred to as the discharging device 303. The ink applying unit is not limited to the illustrated configuration and may vary in number and type.

The aqueous ink discharged onto the intermediate transfer body 301 reacts with the pretreatment fluid on the intermediate transfer body 301.

In this example, the ink discharging device 303 discharges aqueous ink continuously to the pretreatment fluid discharging device 302. As illustrated in FIG. 1, the pretreatment fluid discharging device 302 and the ink discharging device 303 may be disposed adjacent to each other or spaced apart.

The drying devices 305A and 305B are examples of drying units and dry the intermediate transfer body 301 onto which the pretreatment fluid and the aqueous ink have been discharged. Through this process, the intermediate image 310 is formed on the intermediate transfer body 301. In FIG. 1, intermediate images 310K, 310C, and 310Y are illustrated as examples. When referring to intermediate images of black, cyan, magenta, and yellow without distinction, the term “intermediate image 310” may be used. The drying device 305B may also be referred to as a post-drying device, as may the drying device 305A.

The heat roller 306 and the platen roller 309B are examples of transfer units and thermally transfer the intermediate image 310 on the intermediate transfer body 301 to the recording medium 311. In this example, the heat roller 306 and the platen roller 309B form a nip, through which the conveyed intermediate transfer body 301 and the recording medium 311 pass. The intermediate image 310 is transferred onto the recording medium 311 while being subjected to heat and pressure. As a result, a transferred image 312 is formed on the recording medium 311, producing a recorded product. The transferred image 312 may also be simply referred to as an image.

In this example, the recording medium 311 is conveyed through the nip. The white arrow in FIG. 1 indicates the transport direction of the recording medium 311.

The cleaning roller 307 cleans the intermediate transfer body 301 after transfer. For example, the cleaning roller 307 removes residual intermediate image 310 from the intermediate transfer body 301. The cleaning roller 307 is positioned opposite a cleaning counter roller 308, for example.

The following describes the main components of the image forming apparatus according to the present embodiment:
[1] the intermediate transfer body,
[2] the support members,
[3] the pretreatment fluid discharging device,
[4] the aqueous ink discharging device,
[5] the post-drying device,
[6] the thermal transfer device,
[7] the recording medium,
[8] the recording medium conveying device, and
[9] the cleaning device.

### [1] Intermediate Transfer Body

The intermediate transfer body 301, for example, has a surface (on its outermost surface), on which an intermediate image is formed. To improve the transferability of the intermediate image to the recording medium, the surface is preferably made of a material having high releasability.

If the intermediate image and the recording medium are configured to make surface contact during transfer of the intermediate image, the nip state can be maintained. During this time, the intermediate image is efficiently heated, enhancing its transferability. For this reason, it is preferable to use an intermediate transfer body that can be efficiently heated.

The intermediate transfer body 301 may be provided with a surface formed of an elastic material and a substrate, or alternatively, the substrate may be made of a polyamide film or polyimide film provided separately from the substrate.

Materials suitable for forming the surface include highly elastic elastomeric materials such as natural rubber and synthetic rubber; polyolefin resins such as polyethylene and polypropylene; ethylene-propylene-diene monomer (EPDM); silicone rubber; fluorosilicone rubber; phenyl silicone rubber; and fluororubber. Among these, silicone rubber and fluororubber are particularly preferred.

As the substrate to be bonded to the surface, polyethylene terephthalate film, polyamide film, and polyimide film are preferable, with polyimide film being particularly preferred due to its high heat resistance.

If a device such as an infrared heater is used as a pre-drying device, which is described later, it is preferable to incorporate an infrared-absorbing material such as carbon black into the material forming the surface. In such a case, the irradiated infrared light is more readily converted into heat, thereby improving heating efficiency.

The intermediate transfer body may further include a reinforcing layer. The presence of the reinforcing layer helps suppress lateral stretching and maintain stiffness when the intermediate transfer body is mounted on the support member. The reinforcing layer may be provided, for example, above or below the elastic layer, and may be made of a material with high compressive elasticity, such as a woven fabric.

Each layer constituting the intermediate transfer body (e.g., the surface, substrate, and reinforcing layer) can be bonded to one another using an adhesive or double-sided adhesive tape, for example.

The size of the intermediate transfer body can be freely selected in accordance with the recording speed and image size.

Examples of the shape of the intermediate transfer body include sheet-like, roller-like, belt-like, and endless web-like forms.

### [2] Support Member

The intermediate transfer body 301 is supported by the support member. In the present example, the support members are the drive rollers 309A and 309C, and the platen roller 309B; however, this configuration is not limiting and may be modified as appropriate. The intermediate transfer body may, for example, be wound in a belt-like manner around the support members. If the intermediate transfer body is wound around the support member, it is preferable that the transfer body have a certain degree of structural strength from the standpoint of transport accuracy and durability.

Examples of materials for the support members include, but are not limited to, metals, ceramics, and resins.

Among these, metal materials such as stainless steel and aluminum are particularly preferred. By using metal materials, it is possible to ensure the rigidity and dimensional accuracy required to withstand stress during transfer, and also reduce inertia during operation, thereby improving control responsiveness.

### [3] Pretreatment Fluid Discharging Device and Pretreatment Fluid Discharging Process

The image forming apparatus 300 includes a pretreatment fluid discharging device 302 that discharges a pretreatment fluid onto the intermediate transfer body 301.

As described above, the pretreatment fluid discharged onto the intermediate transfer body 301 primarily serves to wet the intermediate transfer body and functions as a pretreatment fluid containing a reactant that reacts with the aqueous ink. By applying the pretreatment fluid to the intermediate transfer body 301, a clean intermediate image can be formed. The discharging process performed by the pretreatment fluid discharging device is referred to as the pretreatment fluid application process.

Regarding the location at which the pretreatment fluid is discharged, preferably, the pretreatment fluid that can be suitably selected is applied over a region on the intermediate transfer body 301 that is larger than the region to which the aqueous ink is applied, and more preferably, it is applied over a region slightly larger than the aqueous ink application region. This allows a clean intermediate image to be formed.

The following reiterates this configuration. Preferably, the area of the pretreatment fluid discharged onto the intermediate transfer body by the pretreatment fluid discharging device is larger than the area of the aqueous ink discharged onto the intermediate transfer body by the aqueous ink discharging device. This configuration is reiterated here from the perspective of the image forming method. Preferably, the area of the pretreatment fluid discharged onto the intermediate transfer body in the pretreatment fluid discharging process is larger than the area of the aqueous ink discharged onto the intermediate transfer body in the aqueous ink discharge process.

The pretreatment fluid discharged onto the intermediate transfer body 301 forms a layer on the intermediate transfer body 301. To efficiently form a thin layer of the pretreatment fluid on the surface of the intermediate transfer body 301, for example, the following approach is preferable.

The pretreatment fluid contains a reactant that aggregates components having anionic groups, such as resins or pigment dispersions in the aqueous ink. The components contained in the pretreatment fluid may be selected as appropriate, but preferably include at least one component selected from inorganic acid salts, organic acid salts, and cationic polymers, as well as water and an organic solvent. This selection enables excellent discharge characteristics and facilitates aggregation of the aqueous ink.

Further details regarding the pretreatment fluid are described in the later section titled “pretreatment fluid.”

As the pretreatment fluid discharging device 302 and the aqueous ink discharge device 303, a liquid discharge head such as an inkjet head may be used, for example.

The amount of pretreatment fluid applied to the intermediate transfer body 301 significantly varies depending on the type of the intermediate transfer body 301 and the recording medium 311. It is, for example, preferably from 0.1 to 500 g/m² and more preferably from 1 to 400 g/m² to enhance the image quality and drying property. If the recording medium 311 is fabric, it is preferably from 100 to 500 g/m², more preferably from 200 to 500 g/m², and furthermore preferably from 300 to 400 g/m².

### [4] Aqueous Ink Discharging Device and Aqueous Ink Discharging Process

The image forming apparatus 300 includes an aqueous ink discharging device 303 (second discharge device) that discharges the aqueous ink onto the intermediate transfer body 301. The ink discharged by the aqueous ink discharging device 303 comes into contact with the pretreatment fluid and reacts with it. The discharging process performed by the aqueous ink discharging device is referred to as the aqueous ink discharge process.

As illustrated in the figure, for example, the image forming apparatus 300 may include aqueous ink discharging devices 303K, 303C, 303M, and 303Y, enabling the application of the aqueous inks of black, cyan, magenta, and yellow onto the intermediate transfer body 301. The ink to be discharged is not limited to these colors, and other color inks such as white ink and transparent ink may also be used.

Detailed examples of the aqueous ink will be described later.

### [5] Post-Drying Device and Post-Drying Process

The post-drying device performs drying after the aqueous ink has been discharged, and constitutes an example of the above-mentioned drying device. The drying device that performs drying after discharging the aqueous ink may also be referred to as a post-drying device. In this example, drying devices 305A and 305B correspond to the post-drying device. The post-drying device may also be referred to as the post-drying means, and the drying performed by the post-drying device may be referred to as the post-drying process or the like. Either or both of drying devices 305B and 305C may be used.

The post-drying device may be selected as appropriate, and examples include heating from the front surface, heating from the back surface, or a combination of these methods.

Preferably, the drying device of the post-drying device is a non-contact method that does not come into direct contact with the layer formed by the aqueous ink. Examples of such non-contact drying methods include:
a hot-air heating mechanism such as a dryer,
a radiant heating mechanism using a halogen heater or infrared heater, and
a heating mechanism using electromagnetic induction.

The drying temperature of the post-drying means (drying device) may be selected as appropriate.

### [6] Thermal Transfer

The image forming apparatus 300 includes a transfer devices that thermally transfers the intermediate image 310 on the intermediate transfer body 301 onto a recording medium 311. As the transfer device in the present embodiment, for example, a heating/fixing mechanism used in electrophotographic image forming apparatuses may be employed.

The transfer device may employ a method in which a nip is formed using two opposing rotating members, and the intermediate transfer body 301 and the recording medium 311 are passed through the nip so that the intermediate image 310 on the intermediate transfer body 301 comes into contact with the recording medium 311 and is thereby transferred. In this case, a heating mechanism is provided in at least one of the two rotating members. Such a method is also referred to as a contact heating/fixing method, and in such a case, the intermediate image 310 can be efficiently transferred to the recording medium 311.

In the example illustrated in FIG. 1, a contact heating/fixing method is used, and the transfer device in this example includes a heat roller 306 (thermal transfer roller) and a platen roller 309B, which are a pair of opposing rotating members. Since the platen roller 309B is positioned opposite the heat roller 306, it may also be referred to as an opposing roller. The heat roller 306 and the platen roller 309B form a nip, through which the intermediate transfer body 301 and the recording medium 311 pass, and the intermediate image 310 is brought into contact with the recording medium 311 and thermally transferred.

In the present embodiment, the transfer device performs thermal transfer at a temperature no lower than the softening point of the resin contained in the aqueous ink. Thermal transfer at a temperature no lower than the softening point of the resin in the aqueous ink causes at least a portion of the resin to melt, enhancing the releasability of the intermediate image 310 and improving transferability. If the thermal transfer temperature is lower than the softening point of the resin, proper transfer may not be achieved.

The transfer device includes the heat roller 306 and an opposing roller (platen roller 309B) facing the heat roller 306.

The intermediate transfer body 301 and the recording medium 311 pass through the nip formed between the heat roller 306 and the platen roller 309B to perform thermal transfer. It is preferable that the temperature during passage through the nip be at least 100 degrees Celsius.

The phrase “temperature during passage through the nip” refers to the surface temperature of the image 312 (transferred image) immediately after passing through the nip. The surface temperature of the image 312 immediately after the passage through the nip can be measured using a non-contact thermometer (for example, product name “IT-314”, available from As One). Due to factors such as the latent heat of water in the image and the heat capacity of the heat roller 306, the surface temperature of the image 312 does not necessarily match the temperature of the heat roller 306.

It is considered that the heating during thermal transfer causes the aqueous ink-based layer to contain less moisture, with large aggregated structures closely packed together, resulting in the appearance of structural viscosity. Accordingly, the viscosity of the ink increases at higher shear rates, making it easier for the ink layer present on raised areas of the recording medium to be pressed into recessed areas by the transfer device, thus reducing the likelihood of voids (non-transfer areas). On the other hand, at lower shear rates, the ink viscosity decreases, and the ink layer is more likely to be pressed into the recessed areas by the transfer device, increasing the likelihood of voids. In addition, since many intermediate transfer body materials have heat resistance of 200 degrees Celsius or lower. From this perspective as well, it is preferable to set the thermal transfer temperature within the range of 100 to 200 degrees Celsius.

The platen roller 309B preferably has appropriate structural strength in terms of conveying precision and durability of the intermediate transfer body 301.

Examples of materials for the platen roller 309B include metal, ceramic, and resin. Among these, a member in which clastic rubber is wound around a metal core is preferable, as it provides the necessary rigidity and dimensional precision to withstand stress during transfer, while also reducing operational inertia and improving control responsiveness.

As the heat roller 306, for example, a roller member incorporating a heating source such as a halogen heater may be used.

The layer structure of the heat roller 306 may include, for example, an elastic layer and a surface layer.

The thermal transfer temperature of the thermal transfer device varies depending on conditions such as the temperature of the heat roller 306, nip width, nip time, and ambient temperature. In the present embodiment, the thermal transfer temperature of the thermal transfer device can be defined based on the surface temperature of the image after it passes through the nip.

Note that the surface temperature of the image 312 may be regarded as the maximum temperature at the surface portion of the image that was in contact with the heat roller 306. The temperature of the portion of the intermediate image 310 that is heated by heat transfer from the heat roller 306 rises, and the heated portion of the image reaches its peak as it passes through the nip.

As described above, the transfer device may employ a contact heating fixing method similar to that used in fixing devices of electrophotographic methods. The following describes an example in which the contact heating fixing method is used in the present embodiment.

In thermal transfer using the contact heating fixing method, the intermediate image 310 on the intermediate transfer body 301 is brought into contact with the recording medium 311, while the liquid components contained in the intermediate image 310 are dried and removed. Additionally, in thermal transfer, the intermediate transfer body 301 and the recording medium 311 are brought into contact and pressed between two rotating bodies to apply heat and fix the image. This heating and fixing enhances the cohesive force of the layer formed by the aqueous ink, thereby improving the abrasion resistance of the image. Furthermore, if the aqueous ink contains resin particles, heat fixing causes the resin particles to melt, which further tends to increase the cohesive strength of the layer formed by the aqueous ink.

As described above, in the present embodiment, the transfer unit may include, as the two rotating bodies, for example, the heat roller 306 and the platen roller 309B. A nip portion through which the intermediate transfer body 301 and the recording medium 311 pass is formed between the heat roller 306 and the platen roller 309B. As the recording medium 311 conveyed by the transport unit and the intermediate transfer body 301 conveyed by the support member pass through the nip portion, the recording medium 311 is pressed against and brought into contact with the intermediate image 310 on the intermediate transfer body 301, while the intermediate image 310 is heated. As a result, the intermediate image 310 can be thermally transferred onto the recording medium 311. In such a contact heating fixing method, the process may be referred to as “fixing the intermediate image 310 onto the recording medium 311” or “thermally transferring the intermediate image 310 onto the recording medium 311.”

In the example described in this embodiment, a heat roller 306 is used but this configuration is not limiting. It may alternatively employ an endless belt disposed, being stretched between two rollers. In this case, thermal transfer can be performed using a heating mechanism that heats the endless belt.

The transfer unit may apply pressure to the intermediate transfer body 301 and the recording medium 311 during thermal transfer. The applied pressure only needs to be sufficient to allow heat to transfer from the transfer device to the image, and is not particularly limited. Preferably, the applied pressure is in the range of 1 kgf/cm² to 20 kgf/cm², and more preferably in the range of 3 kgf/cm² to 5 kgf/cm². The pressure applied to the image by the transfer device can be measured using a surface pressure distribution measuring device (e.g., product name “I-SCAN” available from NITTA Corporation).

### [7] Recording Medium

Any known recording medium may be used as the recording medium 311. Examples of recording media include long continuous media wound into rolls and cut-sheet media trimmed to predetermined dimensions. The materials constituting the recording medium may include materials sch as paper including coated paper or plain paper; films made of plastic or metal; and wooden boards; cardboard.

### [8] Recording Medium Conveying Device

The recording medium 311 is conveyed by a conveying device in the direction indicated by the white arrow in FIG. 1, for example. The conveying device may include, for example, a recording medium feeding roller and a recording medium winding roller. The conveyance speed of the recording medium 311 is preferably determined in consideration of the speed required in each process.

### [9] Cleaning Device and Cleaning Process

The image forming apparatus 300 in this example includes a cleaning device that includes a cleaning roller 307 and a cleaning counter roller 308. The cleaning device may also be referred to as a cleaning device or a washing device. The cleaning performed by the cleaning device is referred to as the cleaning process.

The cleaning device cleans the intermediate transfer body 301, for example, by removing residual ink remaining on the intermediate transfer body 301. The cleaning device may clean the intermediate transfer body 301 by sandwiching it between the cleaning roller 307 and the cleaning counter roller 308.

The cleaning device performs cleaning of the intermediate transfer body 301 after thermal transfer and before the discharge of the pretreatment fluid. As illustrated in the figure, the cleaning device (e.g., the cleaning roller 307) is disposed downstream of the transfer device (e.g., the heat roller 306) and upstream of the pretreatment fluid discharge device 302 in the direction of the conveying direction of the intermediate transfer body 301.

The cleaning device may clean the intermediate transfer body 301 using a cleaning liquid.

There are no particular limitations on the cleaning liquid; it may contain an organic solvent or be an aqueous cleaning solution. A cleaning liquid supply unit may also be provided to supply the cleaning liquid. In addition to rollers, the cleaning device may use other components such as webs.

By cleaning the intermediate transfer body with the cleaning device, degradation in the image quality can be minimized.

A member for removing residual cleaning liquid from the intermediate transfer body 301 after cleaning may also be provided.

By removing residual cleaning liquid or other substances from the intermediate transfer body, degradation in image quality can be more effectively minimized. Examples of methods of removing residual cleaning liquid from the intermediate transfer body include blade removal, brush removal, and liquid absorption using an absorbent. Among these, it is preferable to remove the cleaning liquid from the intermediate transfer body by liquid absorption using an absorbent.

### Ink and Ink Set

The following provides detailed examples of the aqueous ink. The pretreatment fluid and aqueous ink may collectively be referred to as an “ink set. Additionally, the aqueous ink may simply be referred to as “ink” in the following description.

The aqueous ink used in the present disclosure may contain, for example, water, a coloring material, a resin, and an organic solvent, and may furtermore optionally contain a surfactant and other components (A). The aqueous ink may be, for example, a color ink, but may also be a white ink or other types of ink.

In this specification, the term “ink set” refers to the state in which the pretreatment fluid and the aqueous ink are each independently present. For example, the ink set is not limited to a configuration in which a first container storing the pretreatment fluid and a second container storing the aqueous ink are integrated for manufacturing or sale.

### Coloring Material

The coloring material has no specific limit and is suitably selected to suit to a particular application. For example, pigments are usable. As the pigment, an inorganic pigment or organic pigment is included. These can be used alone or in combination. Examples of the pigments include, but are not limited to, black pigments, yellow pigments, magenta pigments, cyan pigments, white pigments, green pigments, orange pigments, and gloss or metallic pigments of gold, silver, and others.

The inorganic pigment mentioned above is not particularly limited and can be suitably selected to suit to a particular application. Examples include, but are not limited to, titanium oxide, iron oxide, calcium oxide, barium sulfate, aluminum hydroxide, barium yellow, cadmium red, and chrome yellow, and carbon black. Of these, titanium oxide is preferable as the white coloring material and carbon black is preferable as the black coloring material.

Carbon black is not particularly limited and it can be suitably selected to suit to a particular application. Specific examples include, but are not limited to, channel black, furnace black, gas black, and lamp black manufactured by a known method such as a contact method, a furnace method, and a thermal method.

The organic pigment is not particularly limited and can be suitably selected to suit to a particular application. Examples include, but are not limited to, azo pigments, polycyclic pigments, dye chelates, nitoro pigments, nitoroso pigments, and aniline black. Of these, azo pigments and polycyclic pigments are preferable.

Specific examples of the azo pigments include, but are not limited to, azo lake, insoluble azo pigments, azo pigment condensates, and chelate azo pigments.

Specific examples of the polycyclic pigments include, but are not limited to, phthalocyanine pigments, perylene pigments, perinone pigments, anthraquinone pigments, quinacridone pigments, dioxazine pigments, indigo pigments, thioindigo pigments, isoindolinone pigments, andquinofuranone pigments.

Specific examples of the dye chelate include, but are not limited to, basic dye type chelates and acid dye type chelates.

Specific examples of the organic pigment include, but are not limited to, C. I. Pigment Yellow 1, C. I. Pigment Yellow 3, C. I. Pigment Yellow 12, C. I. Pigment Yellow 13, C. I. Pigment Yellow 14, C. I. Pigment Yellow 17, C. I. Pigment Yellow 24, C. I. Pigment Yellow 34, C. I. Pigment Yellow 35, C. I. Pigment Yellow 37, C. I. Pigment Yellow 42 (yellow iron oxide), C. I. Pigment Yellow 53, C. I. Pigment Yellow 55, C. I. Pigment Yellow 74, C. I. Pigment Yellow 81, C. I. Pigment Yellow 83, C. I. Pigment Yellow 95, C. I. Pigment Yellow 97 C. I. Pigment Yellow 98 C. I. Pigment Yellow 100 C. I. Pigment Yellow 101 C. I. Pigment Yellow 104 C. I. Pigment Yellow 108 C. I. Pigment Yellow 109 C. I. Pigment Yellow 110 C. I. Pigment Yellow 117 C. I. Pigment Yellow 120 C. I. Pigment Yellow 139 C. I. Pigment Yellow 150 C. I. Pigment Yellow 151 C. I. Pigment Yellow 155 C. I. Pigment Yellow 153 C. I. Pigment Yellow 185 C. I. Pigment Yellow 213 C. I. Pigment Orange 5 C. I. Pigment Orange 13 C. I. Pigment Orange 16 C. I. Pigment Orange 17 C. I. Pigment Orange 36, C. I. Pigment Orange 17, C. I. Pigment Orange 36, C. I. Pigment Red 1, C. I. Pigment Red 2, C. I. Pigment Red 3, C. I. Pigment Red 5, C. I. Pigment Red 17, C. I. Pigment Red 5, C. I. Pigment Red 23, C. I. Pigment Red 22, C. I. Pigment Red 38, C. I. Pigment Red 48:2, C. I. Pigment Red 48:2 (Permanent Red 2B (Ca)), C. I. Pigment Red 48:3, C. I. Pigment Red 48:4, C. I. Pigment Red 49:1, C. I. Pigment Red 52:2, C. I. Pigment Red 53:1, C. I. Pigment Red 57:1 (Brilliant Carmine 6B), C. I. Pigment Red 60:1, C. I. Pigment Red 63:1, C. I. Pigment Red 63:2, C. I. Pigment Red 64:1, C. I. Pigment Red 81, C. I. Pigment Red 83, C. I. Pigment Red 88, C. I. Pigment Red 101 (red iron oxide), C. I. Pigment Red 104, C. I. Pigment Red 105, C. I. Pigment Red 106, C. I. Pigment Red 108 (cadmium red), C. I. Pigment Red 112, C. I. Pigment Red 114, C. I. Pigment Red 122 (quinacridone magenta), C. I. Pigment Red 123, C. I. Pigment Red 146, C. I. Pigment Red 149, C. I. Pigment Red 166, C. I. Pigment Red 168, C. I. Pigment Red 170, C. I. Pigment Red 172, C. I. Pigment Red 177, C. I. Pigment Red 178, C. I. Pigment Red 179, C. I. Pigment Red 184, C. I. Pigment Red 185, C. I. Pigment Red 190, C. I. Pigment Red 193, C. I. Pigment Red 202, C. I. Pigment Red 207, C. I. Pigment Red 208, C. I. Pigment Red 209, C. I. Pigment Red 213, C. I. Pigment Red 219, C. I. Pigment Red 224, C. I. Pigment Red 254, C. I. Pigment Red 264, C. I. Pigment Violet 1 (Rhodamine Lake), C. I. Pigment Violet 3, C. I. Pigment Violet 5:1, C. I. Pigment Violet 16, C. I. Pigment Violet 19, C. I. Pigment Red 23, C. I. Pigment Violet 38, C. I. Pigment Blue 1, C. I. Pigment Blue 2, C. I. Pigment Blue 15 (Phthalocyanine Blue), C. I. Pigment Blue 15:1, C. I. Pigment Blue 15:2, C. I. Pigment Blue 15:3, C. I. Pigment Blue 15:4 (Phthalocyanine Blue), C. I. Pigment Blue 16, C. I. Pigment Blue 17:1, C. I. Pigment Blue 56, C. I. Pigment Blue 60, C. I. Pigment Blue 63, C. I. Pigment Green 1, C. I. Pigment Green 4, C. I. Pigment Green 7, C. I. Pigment Green 8, C. I. Pigment Green 10, C. I. Pigment Green 17, C. I. Pigment Green 18, and C. I. Pigment Green 36.

The BET specific surface area of the pigment has no particular limit and can be suitably selected to suit to a particular application. For example, the specific surface area is preferably from 10 to 1,500 m²/g, more preferably from 20 to 600 m²/g, and furthermore preferably from 50 to 300 m²/g.

The desired BET specific surface area pigment can be obtained by generally performing a size reduction or pulverization treatment. There is no particular limitation on the size reduction or pulverization treatment, and it can be appropriately selected from known methods, such as ball milling, jet milling, or ultrasonic treatment. The pigment may be subjected to a single type of treatment, or a combination of two or more types of treatment may be employed.

There is no particular limitation on the cumulative 50 percent volume particle diameter (D50) of the pigment, and it can be appropriately selected according to a particular application. It is preferably 50 to 350 nm in the ink.

The proportion of the pigment is not particularly limited and can be suitably selected to suit to a particular application. It is preferably from 1.0 to 15.0 percent by mass and more preferably from 1.5 to 10.0 percent by mass in solid to the entire of the ink. If the content (solid content) of the pigment is at least 1.0 percent by mass relative to the entire of the ink, it is preferable because the color development and image density of the ink are improved. If the content (solid content) of the pigment is at most 15.0 percent by mass relative to the entire of the ink, it is preferable because the discharge stability of the ink is improved.

A composite pigment can be used as the pigment in the present disclosure.

From the viewpoint of having a small primary average particle size, preferred examples of the composite pigment include silica/carbon black composite materials (available from TODAKOGYO CORP.), silica/phthalocyanine PB15: 3 composite materials (available from TODAKOGYO CORP.), silica/disazo yellow composite materials (available from TODAKOGYO CORP.), and silica/quinacridone PR 122 composite materials (available from TODAKOGYO CORP.).

Complex pigments of inorganic pigment particles with a primary particle diameter of 20 nm covered with an equivalent amount of an organic pigment have a primary particle diameter of about 25 nm. If such complex pigments are dispersed with a suitable dispersant to their primary particles, ultrafine complex pigment dispersion ink with a dispersion particle diameter of 25 nm can be manufactured. The organic pigment forming the surface of a complex pigment enhances dispersion. A pigment dispersant is selected to stably disperse both the organic pigment and inorganic pigment at the same time, considering that the feature of the inorganic pigment at the center of the complex pigment demonstrates through a thin organic pigment layer with a thickness of about 2.5 nm.

The aqueous ink may contain a resin, and examples of such resins include urethane resins. From the viewpoint of reactivity with the aqueous ink, it is preferable that at least one of the urethane resin and the coloring agent be anionic. That is, the coloring agent is preferably anionic, and more preferably, an anionic pigment.

Examples of the anionic pigment include, but are not limited to, a surfactant dispersion pigment in which a pigment is dispersed with a surfactant, a resin dispersion pigment in which a pigment is dispersed with a resin, a resin coated pigment dispersion in which the surface of a pigment is coated with a resin, a self-dispersion pigment in which a hydrophilic group is provided to the surface of a pigment. Water-dispersible pigments are preferable in any of these dispersion forms.

If the anionic pigment is a resin coted pigment dispersion or self-dispersion pigment, it preferably has at least one hydrophilic group on its surface.

Specific examples of such hydrophilic groups include, but are not limited to, —COOM, —SO₃M, —PO₃HM, —PO₃M₂, —CONM₂, —SO₃NM₂, —NH—C₆H₄—COOM, —NH—C₆H₄—SO₃M, —NH—C₆H₄—PO₃HM, —NH—C₆H₄—PO₃M₂, —NH—C₆H₄—CONM₂, and —NH—C₆H₄—SO₃NM₂. These hydrophilic groups can be introduced by known methods. “M” in the hydrophopbic group represents a counter ion.

The counter ion M in the hydrophilic group is preferably quaternary ammonium ion.

Specific examples of the quaternary ammonium ions include, but are not limited to, tetramethyl ammonium ion, tetraethyl ammonium ion, tetrapropyl ammonium ion, tetrabutyl ammonium ion, tetra pentyl ammonium ion, benzyl trimethyl ammonium ion, benzyl triethyl ammonium ion, and tetrahexyl ammonium ion. Of these, tetraethyl ammonium ion, tetrabutyl ammonium ion, and benzyl trimethyl ammonium ion are preferable and tetrabutyl ammonium ion is more preferable.

Each ink using the pigment mentioned above demonstrates excellent storage stability over time and minimizes an increase in viscosity during moisture vaporing. Due to the hydrophilic group having a quaternary ammonium ion, pigments are considered to be stably dispersed even in an organic rich solvent resulting from moisture evaporation of a water rich solvent.

As an anionic pigment other than the coloring agent having a hydrophilic group on its surface, a polymer emulsion containing a pigment in polymer fine particles is preferable from the viewpoint of storage stability of the ink. In such a polymer emulsion, the pigment may be encapsulated within the polymer fine particles, or may be adsorbed on the surface of the polymer fine particles. In this case, it is not necessary for all of the pigment to be encapsulated within or adsorbed on the polymer fine particles; a portion may be dispersed in the emulsion.

As the polymer for polymer fine particle, vinyl-based polymers, polyester-based polymers, and polyurethane-based polymers are usable. Of these, vinyl-based polymers and polyester-based polymers are preferable.

These can be used alone or in combination.

The mass ratio of the coloring material to the organic solvent is suitably adjusted because it relates to the discharging stability of ink and minimization of fixation of waste ink in the maintenance mechanism in an image forming apparatus. If the inkjet head discharges ink containing a coloring material at a large proportion and an organic solvent at a small proportion, discharging defects may occur as the moisture evaporates around the ink meniscus of nozzles.

### Resin

The aqueous ink may contain a resin, and it is preferable that the aqueous ink contain resin particles.

Examples of the resin particles include polyurethane dispersions and styrene-acrylic resin dispersions.

### Other Resins

The ink may contain, in addition to the above-mentioned resin particles, other resins. There is no particular limitation on such other resins, and they may be appropriately selected depending on a particular application.

For image formation, it is useful for the resin to have excellent film-forming properties, as well as solvent resistance, water resistance, and weather resistance. Examples of such resins include, but are not limited to, condensation-type synthetic resins, addition-type synthetic resins, and natural polymer compounds. These can be used alone or in combination.

Examples of the condensation-type synthetic resins include, but are not limited to, polyester resins, polyepoxy resins, polyamide resins, polyether resins, poly(meth)acrylic resins, acrylic-silicone resins, and fluororesins. Note that in the present specification, the term “(meth)acrylic” refers to either acrylic or methacrylic.

Specific examples of the addition-based synthetic resin include, but are not limited to, polyolefine resin, polystyrene resin, polyvinyl alcohol resin, polyvinyl ester resin, polyacrylic acid resin, and unsaturated carboxylic acid resin.

Specific examples of the natural polymer include, but are not limited to, celluloses, rosins, and natural rubber.

The content of the above-mentioned other resins is not particularly limited as long as the effects of the present invention are not impaired, and may be appropriately set depending on a particular application.

These other resins may be either synthesized or procured. Examples of such procured other resins include, but are not limited to, the following:
Superflex 150HS (polyurethane dispersion, Tg: 32 degrees Celsius, volume average particle diameter: 80 nm, solid content: 38 percent by mass, available from Dainippon Ink and Chemicals, Inc.)
TAKELAC® W-6061 (polyurethane dispersion, Tg: 25 degrees Celsius, volume average particle diameter: 100 nm, solid content: 30 percent by mass, available from Mitsui Chemicals, Inc.)
BONCOAT VF1060 (acrylic emulsion, Tg: −10 degrees Celsius, solid content: 50 percent by mass, available from DIC Corporation)

### White Ink

A white image formed with the white ink on a printing medium serves as a backdrop of a color image formed with the color ink to be applied to the region where the white ink has been applied. The white image enhances the coloring of the color image.

In the present specification, “white” is a color referred to as white appropriately accepted under normal social conventions and includes slightly colored white.

There is no particular limitation on the Hunter whiteness of the white image formed on a recording medium by the white ink, and it may be appropriately selected depending on the intended purpose. A value of at least 75 is preferable, at least 80 is more preferable, and at least 85 is particularly preferable. If the Hunter whiteness of the white image is at least 75, the color development of color images can be improved.

There is no particular limitation on the method for measuring Hunter whiteness, and it may be appropriately selected depending on the purpose. For example, the Hunter whiteness may be calculated using the color values L, a, and b of the white image formed on the recording medium measured by a spectrodensitometer (e.g., X-Rite exact, available from X-Rite, Inc.), according to the following formula 1. Note that L, a, and b are values based on the color representation system defined by the International Commission on Illumination (CIE), and may also be written as “L*”, “a*”, and “b*”

$$Hunter Whiteness = 1 \; 00 - √ [ {( 100 - L )}^{2} + ( {a}^{2} + {b}^{2} ) ] \qquad Formula 1$$

In the present specification, “color ink” refers to a liquid composition for forming a color image. If the color ink and the white ink are used in combination, the liquid composition may form a color image by applying the color ink to a region to which the white ink has been applied. In this specification, the term “color” refers to colors other than “white,” and includes, for example, black, cyan, magenta, and yellow.

### Water

There is no specific limitation to the water and it can be suitably selected to suit to a particular application. For example, pure water such as deionized water, ultrafiltered water, reverse osmosis water, and distilled water, and ultra pure water are suitable.

These can be used alone or in combination.

The proportion of water is not particularly limited and can be suitably selected to suit to a particular application. It is preferably from 10.0 to 90.0 percent by mass and more preferably from 20.0 to 60.0 percent by mass in the ink to quickly dry the ink and stably discharge it.

### Organic Solvent

here is no particular limitation on the organic solvent, and it may be appropriately selected depending on the intended purpose. It is preferable to use an agent having an equilibrium water content of at least 30 percent by mass under an environment of 23 degrees Celsius and 80 percent relative humidity (RH) (hereinafter sometimes referred to as a “humectant”).

Among these, the organic solvent is more preferably one having a boiling point (bp) of 245 degrees Celsius to 290 degrees Celsius and an equilibrium water content of 43 to 49 percent by mass. The selection of organic solvents relates to reducing color bleed and beading, in other words, controlling static surface tension and dynamic surface tension. It also relates to enhancing the discharging stability of ink and reducing the fixation of waste ink in the maintenance mechanism of an image forming apparatus.

Here, the term “equilibrium water content” refers to the amount of water measured after placing a Petri dish containing 1 g of each organic solvent in a desiccator, in which the temperature and humidity are maintained at 23±1 degrees Celsius and 80±3 percent RH, using a saturated aqueous solution prepared by mixing potassium chloride and sodium chloride in a mass ratio of 6:4 (potassium chloride: sodium chloride), and allowing the system to reach equilibrium. The value is then calculated using the following Formula 2.

$$Equilibrium moisture content ( percent by mass ) = [ mositure content absorbed in organic solvent / ( amount of organic solvent + moisture content absorbed in organic solvent ) ] \times 100 \qquad Formula 2$$

One of the humectants is a polyol having an equilibrium moisture content of at least 30 percent by mass in an environment of 23 degrees Celsius and a relative humidity (RH) of 80 percent.

Specific examples of the polyhydric alcohols include, but are not limited to, diethylene glycol (bp 245 degrees Celsius, equilibrium moisture content: 43 percent by mass), tricthylene glycol (bp 285 degrees Celsius, equilibrium moisture content: 39 percent by mass), tetraethylene glycol (bp 324 to 330 degrees Celsius, equilibrium moisture content: 37 percent by mass %), 1,3-butanediol (bp 203 to 204 degrees Celsius, equilibrium moisture content: 35 percent by mass), glycerin (bp 290 degrees Celsius, equilibrium moisture content: 49 percent by mass), diglycerin (bp 270 degrees CelsiusC/15 mmHg, equilibrium moisture content: 38 percent by mass), 1,2,3-butanetriol (bp 175 degrees Celsius/27 mmHg, equilibrium moisture content: 38 percent by mass), and 1,2,4-butanetriol (bp 190 to 191 degrees Celsius/18 mmHg, equilibrium moisture content: 41 percent by mass). Of these, glycerin and 1,3-butanediol are preferable.

These can be used alone or in combination.

Specific examples of the humectants other than polyols include, but are not limited to, 2-methyl-1,3-butane diol (bp of 214 degrees Celsius), 3-methyl-1,3-butane diol (bp of 203 degrees Celsius), dipropylene glycol (bp of 232 degrees Celsius), 1,5-pentane diol (bp of 242 degrees Celsius), propylene glycol (bp of 187 degrees Celsius), 2-methyl-2,4-pentane diol (bp of 197 degrees Celsius), ethylene glycol (bp of from 196 to 198 degrees Celsius), tripropylene glycol (bp of 267 degrees Celsius), hexylene glycol (bp of 197 degrees Celsius), polyethylene glycol (sticky liquid to solid), polypropylene glycol (bp of 187 degrees Celsius), 1,6-hexane diol (bp of from 253 to 260 degrees Celsius), 1,2,6-hexane triol (bp of 178 degrees Celsius), trimethyl ethane (solid, melting point of from 199 to 201 degrees Celsius), and trimethylol propane (solid, melting point of 61 degrees Celsius).

These can be used alone or in combination.

The proportion of the organic solvent is not particularly limited and can be suitably selected to suit to a particular application. It is preferably from 10.0 to 75.0 percent by mass and more preferably from 15.0 to 50.0 percent by mass to the entire ink. It is preferable that the content of the organic solvent be at least 10.0 percent by mass relative to the entire amount of the ink, as this ensures good moisturizing properties of the ink. It is also preferable that the content of the organic solvent is at most 75.0 percent by mass relative to the entire amount of the ink, as this improves the ink's drying performance on the recording medium described later.

Furthermore, if the recording medium described later is non-absorptive (or has low absorbency), it is preferable to use an organic solvent having a solubility parameter (SP value) of 9.0 (cal/cm³)^{1/2} to less than 11.8 (cal/cm³)^{1/2}. Specific examples of organic solvents having a solubility parameter (SP value) within the above-mentioned range include, but are not limited to:
3-ethyl-3-oxetanemethanol (SP value: 11.31 (cal/cm³)^{1/2}),
3-methyl-3-oxetanemethanol (SP value: 11.79 (cal/cm³)^{1/2}),
β-methoxy-N,N-dimethylpropionamide (3-methoxy-N,N-dimethylpropionamide) (SP value: 9.19 (cal/cm³)^{1/2}),
β-butoxy-N,N-dimethylpropionamide (3-butoxy-N,N-dimethylpropionamide) (SP value: 9.03 (cal/cm³)^{1/2}),
1,2-hexanediol (SP value: 11.8 (cal/cm³)^{1/2}),
2-ethyl-1,3-hexanediol (SP value: 10.6 (cal/cm³)^{1/2}),
2,2,4-trimethyl-1,3-pentanediol (SP value: 10.8 (cal/cm³)^{1/2}),
diethylene glycol monoethyl ether (SP value: 10.14 (cal/cm³)^{1/2}),
3-methoxy-1-butanol (SP value: 9.64 (cal/cm³)^{1/2}),
3-methoxy-3-methyl-1-butanol (SP value: 9.64 (cal/cm³)^{1/2}),
3-methyl-1,5-pentanediol (SP value: 11.8 (cal/cm³)^{1/2}),
methylpropylenetriglycol (SP value: 9.43 (cal/cm³)^{1/2}),
diethylene glycol mono-n-butyl ether (SP value: 9.86 (cal/cm³)^{1/2}),
diethylene glycol monomethyl ether (SP value: 10.34 (cal/cm³)^{1/2}),
triethylene glycol monomethyl ether (SP value: 10.12 (cal/cm³) 12),
propylene glycol monopropyl ether (SP value: 9.82 (cal/cm³)^{1/2}),
propylene glycol monomethyl ether (SP value: 10.19 (cal/cm³)^{1/2}),
propylene glycol monobutyl ether (SP value: 9.69 (cal/cm³)^{1/2}),
3-methoxy-1-butanol (SP value: 10.65 (cal/cm³)^{1/2}),
3-methoxy-1-propanol (SP value: 10.41 (cal/cm³)^{1/2}), and
dipropylene glycol monomethyl ether (SP value: 9.84 (cal/cm³)^{1/2}).

Furthermore, if the recording medium described later is non-absorptive (or has low absorbency), there is no particular restriction on the content of organic solvents having an SP value within the above range, and the content can be appropriately adjusted depending on the intended purpose. From the viewpoint of reducing color bleed and beading (in other words, controlling static and dynamic surface tension), as well as from the viewpoint of ink color development, it is preferable that the content be from 0.5 to 5.0 percent by mass relative to the entire amount of the ink, and more preferably from 1.0 to 4.0 percent by mass.

### Surfactant

The aqueous ink preferably contains a surfactant from the perspective of reducing color bleed and beading (i.e., controlling static and dynamic surface tension).

Examples of such surfactants include, but are not limited to, acetylenic surfactants, silicone-based surfactants, and fluorinated surfactants.

Specific examples of the acetylenic surfactants include, but are not limited to, acetylene glycol compounds and acetylene alcohol compounds.

Specific examples of the silicone-based surfactants include, but are not limited to, polyether-modified siloxane compounds.

Specific examples of the fluorinated surfactants include, but are not limited to, fluorinated compounds. Among these, polyether-modified siloxane compounds are preferred from the viewpoint of improved filter pass-through properties and friction resistance.

These can be used alone or in combination.

Inclusion of a surfactant in the ink used in the present disclosure makes it less likely for the ink to wet the ink-repellent film on the nozzle plate of an inkjet head. As a result, ink adhesion to the nozzle can be reduced, thereby preventing discharge defects and improving discharging stability, making it preferable for use.

The polyether-modified siloxane compound mentioned above is preferably represented by the Chemical Formulae 1 to 4 below.

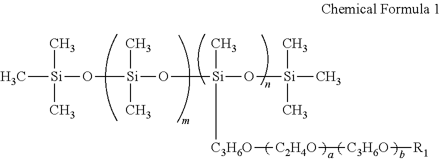

In the Chemical Formula 1, R₁ represents a hydrogen atom or an alkyl group having 1 to 4 carbon atoms, m represents 0 or an integer of from 1 to 23, n represents an integer of from 1 to 10, a represents an integer of from 1 to 23, and b represents 0 or an integer of from 1 to 23.

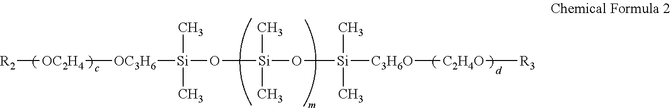

In the Chemical Formula 2, R₂ and R₃ each, independently represent hydrogen atoms or alkyl groups having 1 to 4 carbon atoms, m represents an integer of from 1 to 8, and c and d each, independently represent integers of from 1 to 10.

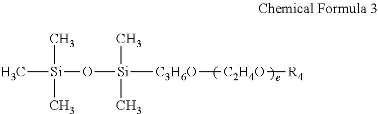

In the Chemical Formula 3, R₄ represents a hydrogen atom or an alkyl group having 1 to 4 carbon atoms and e represents an integer of 1 to 8.

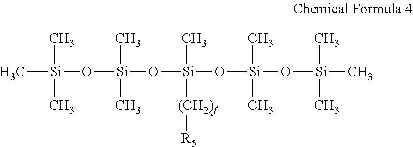

In the Chemical Formula 4, R₅ represents a polyether group represented by the following Formula 5 and f represents an integer of from 1 to 8.

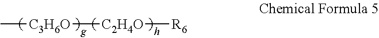

In the Chemical Formula 5, R₆ represents a hydrogen atom or an alkyl group having 1 to 4 carbon atoms, g represents 0 or an integer of from 1 to 23, and h represents 0 or an integer of from 1 to 23. excluding the case in which g and h are simultaneously 0.

The compound represented by Chemical Formula 1 includes, but are not limited to, the compound represented by the Chemical Structures (1) to (8) below.

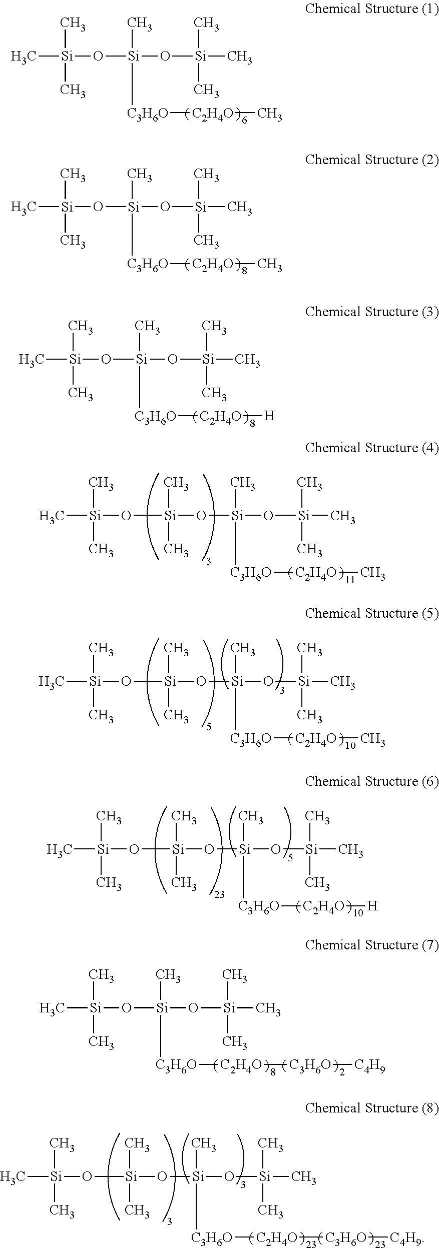

The compound represented by the Chemical Formula 2 includes, but are not limited to, the compound represented by Chemical Structure 9 below.

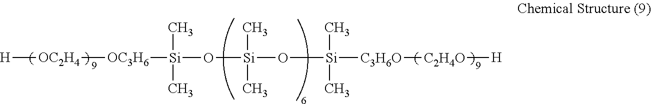

The compound represented by the Chemical Formula 3 includes, but are not limited to, the compound represented by Chemical Structure 10 below.

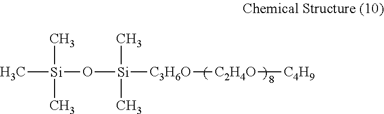

The compound represented by the Chemical Formula 4 includes the compound represented the Chemical Structures 11 to 13 below.

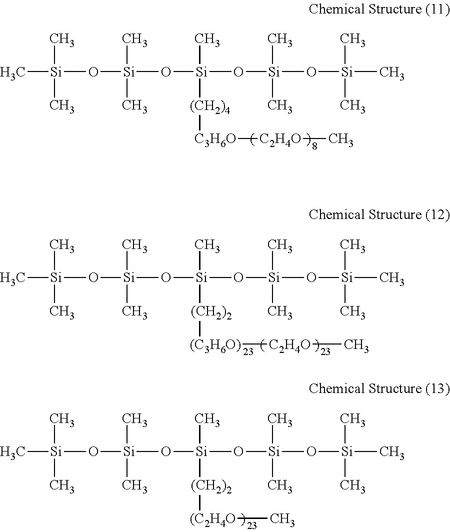

The synthetic polyether-modified siloxane compound can be suitably synthesized or procured.

Specific examples of procurable polyether-modified siloxane compounds include, but are not limited to, KF-353, KF-640, KF-642, KF-643, and KF-644 (all available from Shin-Etsu Chemical Co., Ltd.); EMALEX-SS-5051 (available from Nippon Emulsion Co., Ltd.); BYK-345, BYK-347, BYK-348, BYK-375, BYK-377, and BYK-3451 (all available from BYK-Chemie Japan Co., Ltd.); Silface SAG002, Silface SAG003, Silface SAG005, Silface SAG503A, Silface SAG021, and Silface SAG008 (all available from Nissin Chemical Industry Co., Ltd.); and TEGOR Wet KL245, TEGOR Wet 250, TEGO® Wet 260, TEGO® Wet 265, TEGOR Wet 270, and TEGO® Wet 280 (all available from Evonik Japan Co., Ltd.). Among these, KF-353 (available from Shin-Etsu Chemical Co., Ltd.) is particularly preferred from the viewpoints of improved filter permeability and enhanced rub resistance.

There are no particular restrictions on the acetylenic glycol compounds and acetylenic alcohol compounds; they can be selected as appropriate according to a particular application.

The acetylene glycol compound and acetylene alcohol compounds can be suitably synthesized or procured. Examples of procurable acetylenic glycol compounds and acetylenic alcohol compounds include, but are not limited to: Surfynol 104E (2,4,7,9-tetramethyl-5-decyne-4,7-diol), Surfynol 420, Surfynol 440, Surfynol 465, Surfynol SE, Surfynol SE-F, Surfynol PSA-336, Surfynol DF110D, Surfynol DF58, OLFINE E1004, OLFINE E1010, OLFINE E1020, OLFINE PD-001, OLFINE PD-002W, OLFINE PD-004, OLFINE PD-005, OLFINE EXP.4001, OLFINE EXP.4200, OLFINE EXP.4123, and OLFINE EXP.4300 (all available from Nissin Chemical Industry Co., Ltd.).

The fluorochemical surfactant mentioned above is not particularly limited and can be suitably selected to suit to a particular application.

Specific examples include, but are not limited to, a perfluoroalkyl sulfonic acid compound, perfluoroalkyl carboxylic acid compound, perfluoroalkyl phosphoric acid ester compound, adduct of perfluoroalkyl ethylene oxide, and polyoxyalkylene ether polymer compound having a perfluoroalkyl ether group in its side chain because of their low foaming property.

Specific examples of the perfluoroalkyl sulfonic acid compound include, but are not limited to, perfluoroalkyl sulfonic acid and salts of perfluoroalkyl sulfonic acid.

Specific examples of the perfluoroalkyl carbonic acid compound include, but are not limited to, perfluoroalkyl carbonic acid and salts of perfluoroalkyl carbonic acid.

Specific examples of the polyoxyalkylene ether polymer compound having a perfluoroalkyl ether group in its side chain include, but are not limited to, sulfuric acid ester salts of polyoxyalkylene ether polymer having a perfluoroalkyl ether group in its side chain, and salts of polyoxyalkylene ether polymers having a perfluoroalkyl ether group in its side chain.

There are no particular restrictions on the counter ions of the salts in the above fluorinated compounds, and they may be appropriately selected according to a particular application. Specific examples include, but are not limited to, Li, Na, K, NH₄, NH₃CH₂CH₂OH, NH₂(CH₂CH₂OH)₂, or NH(CH₂CH₂OH)₃.

The fluorinated compound can be synthesized or procured. Specific examples of the procurable fluorinated compounds include, but are not limited to, for instance, Surflon S-242, Surflon S-243, Surflon S-420, and Surflon S-431 (all available from AGC Seimi Chemical Co., Ltd.); Megafac F-251, Megafac F-430, Megafac F-444, Megafac F-477, Megafac F-552, Megafac F-553, and Megafac F-554 (all available from DIC Corporation); CAPSTONE FS-10, CAPSTONE FS-30, CAPSTONE FS-31, CAPSTONE FS-34, CAPSTONE FS-35, CAPSTONE FS-51, CAPSTONE FS-60, CAPSTONE FS-61, CAPSTONE FS-63, CAPSTONE FS-64, CAPSTONE FS-65, and CAPSTONE FS-3100 (all available from Chemours); FUTARGENT 212M, FUTARGENT 215M, FUTARGENT 250, FUTARGENT 251, FUTARGENT 222F, and FUTARGENT 245F (all available from Neos Co., Ltd.); and Polyfox F-136A, PF-156A, and PF-151N (all available from Kitamura Chemical Industry Co., Ltd.). Among these, particularly preferred are CAPSTONE FS-3100 and CAPSTONE FS-34 (available from DuPont), FUTARGENT 250 and FUTARGENT 251 (available from Neos Co., Ltd.), and Polyfox PF-151N (available from Kitamura Chemical Industry Co., Ltd.), as they provide significantly improved print quality-especially in terms of color development, penetration into paper, wettability, and dyeing uniformity.

The proportion of the surfactants is not particularly limited and can be suitably selected to suit to a particular application. It is preferably from 0.001 to 5.0 percent by mass and more preferably from 0.01 to 3.0 percent by mass to the ink. It is preferable that the content of the surfactant be at least 0.001 percent by mass to the entire of the ink, as this content enables color bleed and beading to reduce (in other words, the control of static and dynamic surface tension). Note that if the content of the surfactant exceeds 5.0 percent by mass relative to the entire of the ink, the effect may become saturated.

### Other Components

The other components A are not particularly limited and can be suitably selected to suit to a particular application. They include, but are not limited to, additives.

### Additive

There is no specific limitation to the selection of the additive. For example, foam inhibitors (defoaming agent), pH regulators, preservative and antifungal agent, chelate reagents, corrosion inhibitors, anti-oxidants, ultraviolet absorbers, oxygen absorbers, and photostabilizing agents can be selected.

### Foam Inhibitor (Defoaming Agent)

A foam inhibitor is added in a small amount to the ink to prevent foaming in the ink.

Foaming refers to enclosing air with a thin liquid film. Forming foams is related to the properties of ink, such as surface tension and viscosity. That is, liquid such as water with a strong surface tension makes the surface area as small as possible so it does not readily foam. Conversely, sticky ink with high permeability is likely to foam because it has low surface tension. The foam formed due to this high viscosity does not readily break but is maintained.

Normally, a foam inhibitor breaks foams by locally lowering the surface tension of foam film. Alternatively, a foam inhibitor insoluble in a foaming liquid breaks foams by dotting on the surface of the foaming liquid.

If the ink of the present disclosure contains a polyether-modified siloxane compound as the surfactant, it is preferable that the foam inhibitor contain a compound represented by the following Chemical Formula (6).

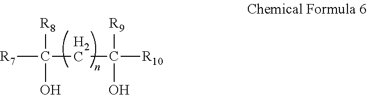

In the Chemical Formula (6), R₇ and R₈ each, independently represent alkyl groups having 3 to 6 carbon atoms, R₉ and R₁₀ each, independently represent alkyl groups having one or two carbon atoms, and n represents an integer of from one to six.

Conversely, the foam inhibitor represented by the following Chemical Formula 6 is less able to reduce the surface tension than a polyether-modified siloxane compound but highly compatible with the polyether-modified siloxane compound. Thus, foam film is considered to take in the foam inhibitor efficiently and locally becomes unstable due to the difference in the surface tension between the foam inhibitor and a polyether-modified siloxane compound. Resultantly, the foam finally breaks.

Specific examples of the compound represented by Chemical Formula 6 include, but are not limited to, 2,4,7,9-tetramethyldecane-4,7-diol and 2,5,8,11-tetramethyl dodecane-5,8-diol. Of these, considering reduction effect on foam production and compatibility with ink, 2,5,8,11-tetramethyldodecane-5,8-diol is preferable.

There is no specific limitation on the content of the foam inhibitor, and it can be appropriately selected according to a particular application. It is preferable that the content of the foam inhibitor be 0.01 to 10.0 percent by mass of the entire of the polyester resin A, with a more preferable range being 0.1 to 5.0 percent by mass. It is preferable that the content of the foam inhibitor be at least 0.01 percent by mass relative to the entire of the ink, as this ensures good foam inhibition of the ink. If the content of the foam inhibitor is at most 10.0 percent by mass relative to the entire of the ink, it is possible to minimize any influence on ink properties such as the particle size of the resin particles.

### pH Regulator

The pH regulator mentioned above is not particularly limited as long as it can adjust the pH of ink and can be suitably selected to suit to a particular application. Specific examples include, but are not limited to, alcohol amines, hydroxides of alkali metal, ammonium hydroxides, phosphonium hydoxides, and carbonates of alkali metal. Among them, alcohol amines are preferable.

These can be used alone or in combination.

Specific examples of the alcohol amines include, but are not limited to, diethanolamine, triethanolamine, and 2-amino-2-ethyl-1,3-propanediol.

Specific examples of the hydroxides of alkali metal elements include, but are not limited to, lithium hydroxide, sodium hydroxide, and potassium hydroxide.

Specific examples of the hydroxides of ammonium include, but are not limited to, ammonium hydroxides and quaternary ammonium hydroxides.

A specific example of the phosphonium hydroxides is quaternary phosphonium hydroxide.

Specific examples of the carbonates of alkali metal include, but are not limited to, lithium carbonate, sodium carbonate, and potassium carbonate.

Any proportion of the pH regulator is allowed. It can be suitably selected to suit to a particular application as long as it can achieve a desired pH of the ink.

### Preservative and Antifungal Agent

The preservative and antifungal agent is not particularly limited and may be appropriately selected according to a particular application. Specific examples include, but are not limited to, 1,2-benzisothiazolin-3-one, sodium dehydroacetate, sodium sorbate, sodium 2-pyridinethiol-1-oxide, sodium benzoate, and sodium pentachlorophenate.

These can be used alone or in combination.

The content of the above-mentioned preservative and antifungal agent is not particularly limited as long as the effects of the present disclosure are not impaired, and may be appropriately determined according to a particular application.

The preservative and antifungal agent can be synthesized or procured. Examples of procurable preservative and antifungal agent include, but are not limited to, PROXEL® GXL (a preservative and antifungal agent containing 1,2-benzisothiazolin-3-one as the main component, available from Nitto Denko Avecia Inc.; 20 percent active ingredient, containing dipropylene glycol).

### Chelate Reagent

The chelate reagent is not particularly limited and it can be suitably selected to suit to a particular application. Specific examples include, but are not limited to, ethylene diamine sodium tetraacetate, nitrilo sodium triacetate, hydroxyethylethylene diamine sodium tri-acetate, diethylenetriamine sodium quinternary acetate, and uramil sodium diacetate.

These can be used alone or in combination.

The content of the chelate reagent is not particularly limited as long as the effects of the present disclosure are not impaired, and may be appropriately set depending on a particular application.

### Corrosion Inhibitor

The corrosion inhibitor is not particularly limited and it can be suitably selected to suit to a particular application.

Specific examples include, but are not limited to, acid sulfite, thiosodium sulfate, antimony thioglycollate, diisopropyl ammonium nitrite, pentaerythritol tetranitrate, and dicyclohexyl ammonium nitrite.

These can be used alone or in combination.

The content of the above-mentioned corrosion inhibitor is not particularly limited as long as the effects of the present disclosure are not impaired, and may be appropriately determined according to a particular application.

### Anti-oxidant

The anti-oxidant is not particularly limited and it can be suitably selected to suit to a particular application. Specific examples include, but are not limited to, phenol-based anti-oxidants (including hindered phenol-based anti-oxidants), amino-based anti-oxidants, sulfur-based anti-oxidants, and phosphorous-based anti-oxidants.

These can be used alone or in combination.

The content of the above-mentioned anti-oxidant is not particularly limited as long as the effects of the present disclosure are not impaired, and may be appropriately determined according to a particular application.

### Ultraviolet Absorber

The ultraviolet absorbents is not particularly limited and it can be suitably selected to suit to a particular application.

Specific examples include, but are not limited to, benzophenone-based ultraviolet absorbents, benzotriazole-based ultraviolet absorbents, salicylate-based ultraviolet absorbents, cyanoacrylate-based ultraviolet absorbents, and nickel complex salt-based ultraviolet absorbents.

These can be used alone or in combination.

The content of the above-mentioned ultraviolet absorbent is not particularly limited as long as the effects of the present disclosure are not impaired, and may be appropriately determined according to a particular application.

### Property of Ink

Properties of the aqueous ink of the present disclosure are not particularly limited and they can be suitably selected to suit to a particular application. The ink preferably has properties such as viscosity, surface tension, and pH in the following ranges.

Viscosity of the ink at 25 degrees Celsius is preferably from 5 to 25 mPa s and more preferably from 6 to 20 mPa·s. It is preferable that the viscosity of the ink at 25 degrees Celsius be at least 5 mPa·s, as this range provides improved image density and text quality. It is also preferable that the viscosity of the ink at 25 degrees Celsius be at most 25 mPa·s as this improves the discharge stability of the ink.

Viscosity can be measured with equipment such as a rotatory viscometer, RE-80L, available from TOKI SANGYO CO., LTD. The measuring conditions are as follows:
Standard cone rotor (1°34′ x R₂₄)·
Sample liquid amount: 1.2 mL
Rate of rotations: 50 rotations per minute (rpm)·
25 degrees C.
Measuring time: three minutes.

The surface tension of the ink is preferably at most 22 mN/m as measured by the dynamic surface tension at 25 degrees Celsius with a bubble life time of 1500 msec, from the viewpoint of achieving suitable ink leveling on the intermediate transfer body and forming high-quality images. More preferably, it is at most 21 mN/m.

The pH of the ink is preferably from 7 to 12 to discharge the ink stably.

The pH can be measured, for example, at 25 degrees Celsius using a pH meter (Model HM-30R, available from DKK-TOA CORPORATION).

### Method of Manufacturing Ink

The ink can be produced by stirring and mixing the above-described materials, for example, using equipment such as a sand mill, homogenizer, ball mill, paint shaker, or ultrasonic disperser.

### Ink Composition Analysis Method

The composition of the ink according to the present disclosure can be analyzed using devices such as a gas chromatograph-mass spectrometer (GC-MS, available from Shimadzu Corporation) or a simultaneous TG/DTA measuring device.

### Pretreatment Fluid

Next, detailed examples of the pretreatment fluid will be described. In order to distinguish components contained in the pretreatment fluid from those contained in the aqueous ink, the components of the pretreatment fluid that are the same as those in the aqueous ink may be indicated with the symbol “(2)”.

The pretreatment fluid is a liquid composition applied to the intermediate transfer body prior to the application of the aqueous ink (ink). By applying the pretreatment fluid before the ink, aggregation and thickening of the subsequently applied ink can be induced, thereby improving adhesion.

The pretreatment fluid contains a reactant that reacts with the aqueous ink (ink). For example, the pretreatment fluid may contain water and a reactant (aggregating agent or fluocculant), and may furthermore optionally contain resin (2), wax (2), organic solvent (2), surfactant (2), and other components (B).

The pretreatment fluid preferably contains at least one selected from inorganic acid salts, organic acid salts, and cationic polymers, along with water and an organic solvent. In this case, both reactivity with the ink and discharge stability can be ensured.

### Water

There is no specific limitation to the water and it can be suitably selected to suit to a particular application. For example, pure water such as deionized water, ultrafiltered water, reverse osmosis water, and distilled water, and ultra pure water are suitable.

The proportion of water is not particularly limited and can be suitably selected to suit to a particular application. It is preferably from 10.0 to 90.0 percent by mass and more preferably from 20.0 to 60.0 percent by mass in the ink to quickly dry the pretreatment fluid.

### Reactant (Aggregating Agent)

The pretreatment fluid contains a reactant that reacts with the aqueous ink (ink). This reactant may also be referred to as an aggregating agent. In the present specification, the term “aggregating agent” refers to a component that causes the ink to aggregate or thicken when the pretreatment fluid comes into contact with the ink. Examples include, but are not limited to, components that aggregate anionic compounds contained in the ink (such as coloring materials or urethane resins). By using a pretreatment fluid containing such an aggregating agent, the ink that comes into contact with the pretreatment fluid can be aggregated or thickened, thereby improving the adhesion of the ink to the surface of the recording medium.

Examples of the reactant (aggregating agent) include at least one agent selected from inorganic acid salts, organic acid salts, and cationic polymers. There are no particular limitations on the aggregating agent, and it may be appropriately selected according to a particular application. Examples include, but are not limited to, cationic compounds. Preferred cationic compounds include those selected from inorganic metal salts, organic acid metal salts, organic acid ammonium salts, and cationic polymers, with inorganic metal salts and cationic polymers being more preferable.

These can be used alone or in combination.

Specific examples of the inorganic metal salt include, but are not limited to, magnesium sulfate, aluminum sulfate, manganese sulfate, nickel sulfate, iron (II) sulfate, copper (II) sulfate, zinc sulfate, iron (II) nitrate, iron (III) nitrate, cobalt nitrate, strontium nitrate, copper (II) nitrate, nickel (II) nitrate, lead (II) nitrate, manganese (II) nitrate, nickel (II) chloride, calcium chloride, tin (II) chloride, strontium chloride, barium chloride, magnesium chloride, sodium sulfate, potassium sulfate, lithium sulfate, sodium hydrogensulfate, potassium hydrogensulfate, sodium nitrate, potassium nitrate, sodium carbonate, potassium carbonate, sodium hydrogencarbonate, potassium hydrogencarbonate, sodium chloride, and potassium chloride. Among these, magnesium sulfate and potassium chloride are preferred as the inorganic metal salts.

Specific examples of the organic acid metal salts include, but are not limited to, L-sodium aspartate, L-magnesium aspartate, calcium ascorbate, L-sodium ascorbate, sodium succinate, disodium succinate, aluminum citrate, potassium citrate, calcium citrate, tripotassium citrate, trisodium citrate, diammonium citrate, disodium citrate, zinc lactate, aluminum lactate, potassium lactate, calcium lactate, sodium lactate, magnesium lactate, calcium acetate, potassium tartrate, calcium tartrate, DL-sodium tartrate, and sodium potassium tartrate.

The inorganic metal salt and organic metal salt are preferably either member selected from the group consisting of a calcium salt, a magnesium salt, a nickel salt, and aluminum salt. By using the inorganic metal salt and the organic acid metal salt as such salts, the aggregating effect on the urethane resin contained in the ink is enhanced, making it possible to more effectively reduce the occurrence of color bleed and beading, while also improving the storage stability of the pretreatment fluid, which is preferable.

Specific examples of the organic acid ammonium salt include, but are not limited to, ammonium acetate, ammonium propionate, ammonium oxalate, ammonium tartrate, ammonium succinate (diammonium succinate), diammonium maronate, diammonium hydrogen citrate, hydrogen citrate, triammonium citrate, and ammonium L-glutaminate.

As the cationic polymer, quaternary ammonium salt type cationic polymers are preferable.

Specific examples include, but are not limited to, polymers of dialkylaryl ammonium chloride, polymers of dialkyl aminoethyl(meth)acrylate quaternary ammonium salts, polymers of modified polyvinyl alcohol dialkyl ammonium salts, and polymers of dialkyl diallyl ammonium salts.

Specific examples of the other cationic polymers other than the specified above include, but are not limited to, cationic specially-modified polyamine compounds, cationic polyamide polyamine compounds, cationic urea-formarine resin compounds, cationic polyacrylic amide compounds, cationic alkyl ketene dimers, cationic dicyane diamide compounds, cationic dicyan diamide-formarine condensation compounds, cationic dicyan diamide-polyamine condensation compounds, cationic polyvinyl formamide compounds, cationic polyvinyl pyridine compounds, cationic polyalkylene polyamine compounds, and cationic epoxy polyamide compounds.

The compounds represented by the Chemical Formulae 7 to 10 are preferable in particular.

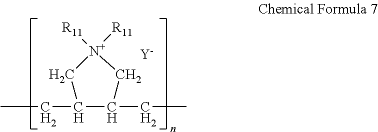

In the Chemical Formula 7, Rn each, independently represents a methyl or ethyl group and Y represents a halogen ion, and n represents an integer.

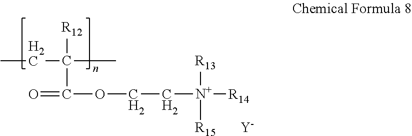

In the Chemical Formula 8, Y-represents a halogen ion, nitrate ion, nitrite ion, or acetate ion, R₁₂ represent a hydrogen or CH₃, R₁₃, R₁₄, and R₁₅ each, independently represent hydrogen atoms or alkyl groups, and N represents an integer.

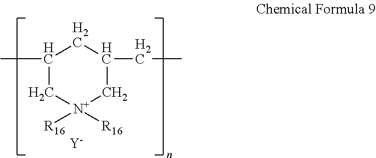

In the Chemical Formula 9, R₁₆ each, independently represents a methyl or ethyl group and Y-represents a halogen ion, nitrate ion, nitrite ion, or acetate ion, and n represents an integer.

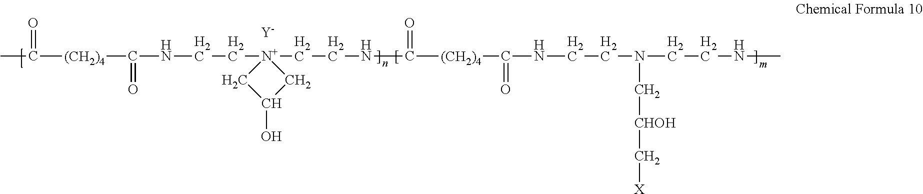

In the Chemical Formula 10, Y-represents a halogen ion, nitrate ion, nitrite ion, or acetate ion; X represents a halogen atom; n represents an integer of 1 to 3; and m represents an integer of 1 to 3.

The content of the aggregating agent to the mass of pretreatment fluid is not particularly limited and it can be suitably elected to suit to a particular application. It is from 0.1 to 30.0 percent by mass and more preferably from 1.0 to 20.0 percent by mass to enhance the solubility of aggregating agent and minimize the occurrence of color bleed and beading.

### Resin 2

In the present specification, the resin contained in the pretreatment liquid may be referred to as “resin (2).” It should be noted that resin (2) is different from resin (1) contained in the pretreatment fluid and from the resin contained in the ink. The inclusion of resin (2) in the pretreatment liquid enhances the adhesion of the ink to the recording medium.

Resin (2) is preferably a nonionic resin dispersed by steric hindrance rather than a commonly used charge-repulsion-type emulsion, from the standpoint of long-term storage stability. The use of a nonionic resin as resin (2) is preferable because it resolves the following issues:

If an anionic resin, which is a charge-repulsion-type emulsion, is used as resin (2), aggregation occurs between the anionic resin and an inorganic metal salt, which is one example of the aggregating agent.

If an anionic resin, which is a charge-repulsion-type emulsion, is used as resin (2), instantaneous aggregation occurs between the anionic resin and a metal multivalent salt that generates trivalent cations upon dissociation.

Cationic resin particles are sufficiently stable when left in a room temperature environment. However, the cationic resin particles become sticky if heated and allowed to stand in an acceleration test for long-term stability.

If a cationic resin is used as the resin (2), it remains sufficiently stable when left at room temperature, but thickening occurs when it is left to stand under heated conditions as an accelerated test anticipating long-term stability.

The nonionic resin particle is not particularly limited and it can be suitably selected to suit to a particular application.

Specific examples include, but are not limited to, polyolefin resin, chlorinated polyolefin resin, polyvinyl acetate resin, polyester resin, polyurethane resin, acrylic resin, styrene butadiene resin, and copolymers of polymerizable compounds for use in polymerization of these resins. Among these, ethylene-vinyl acetate copolymer resin, ethylene-vinyl acetate-vinyl chloride copolymer resin, ethylene-vinyl acetate-vinyl versatate copolymer, and chlorinated olefin resin are preferred. These resins can further improve the adhesion of the ink to the recording medium.

These can be used alone or in combination.

There is no particular limitation on the method of determining whether the resin (2) is nonionic. One way of determining whether the resin (2) is nonionic is to isolate the solid content of a pretreatment fluid by centrifugation, followed by GC-MS analysis (e.g., GCMS-QP2020NX, available from Shimadzu Corporation) to confirm that no materials with acidic functional groups such as carboxyl and sulfoxyl, or basic functional groups such as amino, are present.

There are no particular restrictions on the shape of the resin (2), and it can be suitably selected to suit to a particular application, whether it is regular or irregular. Of these, regular shapes are preferable. If the resin (2) has a regular shape, it is preferably spherical. In the case of a spherical resin (2), it is preferable for it to be in the form of particles.

The glass transition temperature Tg of the nonionic resin is not particularly limited and it can be suitably selected to suit to a particular application. It is preferably from −30 to 30 degrees Celsius and more preferably from −25 to 25 degrees Celsius. A Tg of at least-30 degrees Celsius strengthens a resin film, which toughens a layer formed of a pretreatment fluid. In addition, if the glass transition temperature Tg of the nonionic resin is at most 30 degrees Celsius, the film-forming property of the resin is enhanced and flexibility is ensured, thereby further improving the adhesion of the ink to the recording medium.

The glass transition temperature Tg of the nonionic resin can be measured, for example, using a DSC-60A Plus with a cooling unit, available from Shimadzu Corporation.

The volume average particle diameter of the nonionic resin has no particular limit. For example, it preferably has a volume average particle diameter of from 50 nm to 1000 nm and more preferably from 100 nm to 1000 nm.

The volume average particle diameter of the nonionic resin can be measured using, for example, a Nanotrac particle size distribution analyzer (Nanotrac Wave II-UT151, available from MicrotracBEL Corp.).

There is no specific limit to the content (solid portion) of the resin (2) and it can be suitably selected to suit to a particular application. It is preferably 0.5 to 20.0 percent by mass to the entire of the pretreatment fluid.

The content (solid content) of the resin (2) is 0.5 to 20.0 percent by mass relative to the entire of the pretreatment fluid, thereby further improving the adhesion of the ink to the recording medium.

### Wax

There is no specific limitation to the resin (2) and it can be suitably selected to suit to a particular application. One example is a water-dispersible.

Specific examples include, but are not limited to, plant and animal or plant wax such as carnauba wax, Candelilla wax, bee wax, rice wax, and lanoline, petrol-based wax such as polyethylene wax, microcrystalline wax, polyethylene wax, polypropylene wax, oxidized polyethylene wax, and pterolatum, mineral wax such as montan wax and ozokerite, synthetic wax such as carbon wax, Hoechst wax, polyethylene wax, and stearic acid amide. Among these, from the viewpoint of improving the adhesion of the ink to the recording medium and the dispersibility in the pretreatment fluid, paraffin wax and polyethylene wax are preferred, with paraffin wax being more preferred.

These can be used alone or in combination.

The melting point of the wax is not particularly limited and can be suitably selected to suit to a particular application. The melting point is preferably from 50 to 130 degrees Celsius and more preferably from 60 to 120 degrees Celsius. By setting the melting point of the wax to 50 to 130 degrees Celsius, the adhesion of the ink to the recording medium can be further improved.

The volume average particle diameter of the wax is not particularly limited and can be suitably selected to suit to a particular application. It is preferably from 1 to 20 μm and preferably from 1 to 5 μm.

The volume average particle diameter of the wax can be measured by using a device such as a particle size analyzer (Nanotrac Wave II-UT151, available from MicrotracBEL Corp.).

There is no specific limit on the content of the wax (solid content), and it can be appropriately selected according to the purpose. It is preferable that the content of the wax be 0.05 to 5.0 percent by mass of the entire of the pretreatment fluid, with a more preferable range being 0.1 to 3.0 percent by mass. If the content (solid content) of the wax is 0.05 to 5.0 percent by mass relative to the entire of the pretreatment fluid, it becomes easier to retain the white ink near the surface of the recording medium, thereby improving Hunter whiteness.

### Organic Solvent 2

In the present specification, the organic solvent contained in the pretreatment fluid may be referred to as “organic solvent (2).” It should be noted that the organic solvent (2) is different from the organic solvent contained in the ink.

Specific examples of the water-soluble organic solvent include, but are not limited to: polyhydric alcohols such as ethylene glycol, propylene glycol, diethylene glycol, 1,3-propanediol, 1,2-butanediol, 1,3-butanediol, 1,4-butanediol, 2,3-butanediol, 3-methyl-1,3-butane diol, triethylene glycol, polyethylene glycol, polypropylene glycol, 1,2-pentanediol, 1,3-pentanediol, 1,4-pentanediol, 2,4-pentanediol, 1,5-pentanediol, 1,2-hexanediol, 1,6-hexanediol, 1,3-hexanediol, 2,5-hexanediol, 1,5-hexanediol, glycerin, 1,2,6-hexanetriol, 2-ethyl-1,3-hexanediol, ethyl-1,2,4-butane triol, 1,2,3-butanetriol, 2,2,4-trimethyl-1,3-pentanediol, petriol, and 3-methoxy-3-methyl-1-butanol; polyol alkyl ethers such as ethylene glycol monoethyl ether, ethylene glycol monobutyl ether, diethylene glycol monomethyl ether, diethylene glycol monoethyl ether, diethylene glycol monobutyl ether, tetraethylene glycol monomethyl ether, and propylene glycol monoethyl ether; polyol aryl ethers such as ethylene glycol monophenyl ether and ethylene glycol monobenzyl ether; nitrogen-containing heterocyclic compounds such as 2-pyrrolidone, N-methyl-2-pyrrolidone, N-hydroxyethyl-2-pyrrolidone, 1,3-dimethyl-2-imidazolidinone, ε-caprolactam, and γ-butyrolactone; amides such as formamide, N-methylformamide, N,N-dimethylformamide, 3-methoxy-N,N-dimethyl propioncamide, and 3-buthoxy-N,N-dimethyl propioncamide; amines such as monoethanolamine, diethanolamine, and triethylamine; sulfur-containing compounds such as dimethyl sulfoxide, sulfolane, and thiodiethanol; propylene carbonate, and ethylene carbonate.

As the organic solvent (2), an organic solvent with a boiling point of at most 250 degrees Celsius is preferable to enhance the drying property in addition to acting as humectant.

Among these, from the viewpoint of improving wettability on the surface of the recording medium, propylene glycol, 1,3-butanediol, and 1,2-butanediol are preferred.

The proportion of the organic solvent (2) in the pretreatment fluid (2) is not particularly limited and can be suitably selected to suit a particular application. It is preferably from 5.0 to 60.0 percent by mass and more preferably from 10.0 to 30.0 percent by mass to the entire mass of the pretreatment fluid to quickly dry and reliably discharge the pretreatment fluid.

### Surfactant (2)

In the present specification, the surfactant contained in the pretreatment fluid may be referred to as “surfactant (2).” The surfactant (2) is different from the surfactant contained in the ink.

The surfactant (2) has no particular limit and can be suitably selected to suit to a particular application. For example, anionic surfactants, silicone-based surfactants, nonionic surfactants, amphoteric surfactants, and fluoro-surfactants are suitable. These can be used alone or in combination.

### Silicone-Based Surfactant

There is no specific limitation to the silicone-based surfactant and it can be suitably selected to suit to a particular application. Of these, silicone-based surfactants that are not decomposed in a high pH range of 11 to 14 are preferable.

Specific examples of the silicone-based surfactant that are not decomposed in a high pH environment of 11 to 14 include, but are not limited to, side-chain modified polydimethyl siloxane, both-terminal modified polydimethyl siloxane, one-terminal-modified polydimethyl siloxane, and side chain both-terminal modified polydimethyl siloxane. Of these, a silicone-based surfactant with a polyoxyethylene or polyoxyethylene-polyoxypropylene group as a modifying group is preferable to enhance hydrophilicity and increase solubility in water.

It is also possible to use a polyether-modified silicone-based surfactant as the silicone-based surfactant. As the polyether-modified silicone-based surfactant, one of which is a compound in which a polyalkylene oxide structure is introduced into the side chain of the Si site of dimethyl silooxane.

The fluorinated surfactant is not particularly limited and may be appropriately selected to suit to a particular application, but the same fluorinated surfactant as that contained in the ink may be used, and the preferred embodiments are also the same.

The amphoteric surfactant is not particularly limited and can be suitably selected to suit to a particular application.

Specific examples include, but are not limited to, lauryl aminopropionic acid salts, lauryl dimethyl betaine, stearyl dimethyl betaine, and lauryl dihydroxyethyl betaine.

The nonionic surfactant is not particularly limited and it can be suitably selected to suit to a particular application.

Specific examples include, but are not limited to, polyoxyethylene alkyl phenyl ethers, polyoxyethylene alkyl esters, polyoxyethylene alkyl amines, polyoxyethylene alkyl amides, polyoxyethylene propylene block polymers, sorbitan aliphatic acid esters, polyoxyethylene sorbitan aliphatic acid esters, and adducts of acetylene alcohol with ethylene oxides.

The anionic surfactant is not particularly limited and can be suitably selected to suit to a particular application. Specific examples include, but are not limited to, salts such as a polyoxyethylene alkylether acetate, a dodecylbenzene sulfonate, a laurate, and a polyoxyethylene alkylether sulfate.

### Other Component B

The other components B are not particularly limited and can be suitably selected to suit to a particular application unless it adversely impacts the effects of the present disclosure. It includes, for example, a defoaming agent, a preservative and antifungal agent, and a corrosion inhibitor.

### Defoaming Agent

The same defoamer as the one described under the section Other Component A above—foam inhibitor (defoaming agent)—may be used as the defoamer. The defoaming agent is not particularly limited and it can be suitably selected to suit to a particular application. It includes, but is not limited to, a silicon-based defoaming agent, polyether-based defoaming agent, and aliphatic acid ester-based defoaming agent. Of these, silicone-based defoaming agents are preferable to enhance the ability of braking foams.

These can be used alone or in combination.

### Preservative and Antifungal Agent

The same preservative and antifungal agent as the one described under the section Other Component A above—preservative and antifungal agent—may be used.

### Corrosion Inhibitor

The same corrosion inhibitors as the one described under the section Other Component A above—corrosion inhibitors—may be used.

From the viewpoint of enabling the pretreatment fluid to level suitably on the intermediate transfer member and form a clean image, the surface tension of the pretreatment fluid is preferably at most 22 mN/m, more preferably at most 21 mN/m, in terms of dynamic surface tension at 25 degrees Celsius with a bubble life time of 1500 msec.

The terms of image forming, recording, and printing in the present disclosure represent the same meaning.

Also, recording media, media, and print substrates in the present disclosure have the same meaning unless otherwise specified.

Having generally described preferred embodiments of this disclosure, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

Next, embodiments of the present disclosure are described in detail with reference to Examples but are not limited thereto.

“Parts” represents parts by mass and “percent” represents percent by mass unless otherwise specified in the following description.

### Preparation of Pretreatment Fluid

Pretreatment fluids 1 to 8 were prepared by the methods described below.

Preparation Example 1 of Pretreatment Fluid: Manufacturing of Pretreatment Fluid

A glass beaker was charged with 6.67 parts of a cationic surfactant (Quartamin 60W, available from Kao Corporation) and 30.00 parts of highly pure water, followed by stirring for 5 minutes. Subsequently, 30.00 parts of propylene glycol, 5.00 parts of 3-methyl-1,3-butanediol, 1.00 part of Silface SAG503A (available from Nissin Chemical co.,ltd.), and 0.50 part of TEGO® Wet 270 (available from Evonik Japan Co., Ltd.) were added, followed by stirring for 15 minutes. Then 0.50 parts of a foam inhibitor (2,5,8,11-tetramethyldodecane-5,8-diol), 0.05 parts of a preservative and antifungal agent (PROXEL® GXL), and 0.10 parts of 1,2,3-benzotriazole (available from Tokyo Chemical Industry Co., Ltd.) were added and mixed by stirring for 15 minutes. Thereafter, highly pure water was added as balance to make the total 100 parts by mass followed by stirring for 10 minutes. The thus-obtained mixture was filtered with a polyvinilydene fluoride membrane filter having an average pore diameter of 5.0 μm under pressure to remove dust such as insoluble matter to prepare Pretreatment Fluid 1.

### Preparation Examples 2 to 8: Manufacturing of Pretreatment Fluids 2 to 8

The Pretreatment Fluids 2 to 8 were prepared in the same manner as in Preparation Example 1 of Pretreatment Fluid except that the prescription of the pretreatment fluid was changed to materials and the proportions as shown in the following Table 1.

The content of each material is represented in percent by mass in Table 1 below. It does not represent the content of solid portion or active ingredient but all included.

The details of each material shown in Table 1 below are as follows.

### Salt of Inorganic Acid

Magnesium sulfate hexahydrate (available from FUJIFILM Wako Pure Chemical Corporation)
Calcium nitrate tetrahydrate (available from FUJIFILM Wako Pure Chemical Corporation)

### Salt of Organic Acid

Ammonium lactate aqueous solution (active ingredient of 40 percent, available from FUJIFILM Wako Pure Corporation)
Calcium lactate: available from Fuso Chemical Co., Ltd.

### Cationic Polymer

SHALLOL® DC-902P: polydimethyl diallyl ammonium chloride, solid content of 51.0 percent by mass, available from DKS Co., Ltd.

### Surfactant

SILFACE SAG503A: Polyether-modified siloxane compound, active ingredient of 100 percent, available from Nisshin Chemical Co., Ltd.
SILFACE SAG021: Polyether-modified siloxane compound, active ingredient of 100 percent, available from Nisshin Chemical Co., Ltd.
TEGO® Wet 270: Polyether-modified siloxane compound, active ingredient of 100 percent, available from Evonik Industries AG
BYK-3451: Polyether modified siloxane (active ingredient of 100 percent, available from BYK Japan KK.)
Capstone FS-3100: Partially fluorinated alcohol-substituted glycol compound, available from The Chemours Company, active ingredient 100 percent
Quartamin 60W: Cetyltrimethylammonium chloride (cationic surfactant), available from Kao Corporation, active ingredient 30 percent

### Preservative and Antifungal Agent

PROXEL® GXL: preservative and antifungal agent containing 1,2-benzisothiazolin-3-one as the main component (available from Nitto Denko Avecia, active ingredient 20 percent, containing dipropylene glycol)

TABLE 1

| | | Concentration | | | |
|---|---|---|---|---|---|
| | | of solid portion | Pretreatment | Pretreatment | Pretreatment |
| Component (percent by mass) | | (percent by mass) | fluid 1 | fluid 2 | fluid 3 |
| Organic | Propylene glycol | 100 percent | 30.00 | 30.00 | 30.00 |
| solvent | 3-Methyl-1,3-butane | 100 percent | 5.00 | 5.00 | 5.00 |
| | diol | | | | |
| | Propylene glycol | 100 percent | — | — | — |
| | mono-propyl ether | | | | |
| Surfactant | SILFACE SAG503A | 100 percent | 1.00 | 1.00 | 1.00 |
| | SILFACE SAG021 | 100 percent | — | — | — |
| | TEGO ® Wet 270 | 100 percent | 0.50 | 0.10 | 1.00 |
| | BYK-3451 | 100 percent | — | — | — |
| | Capstone FS-3100 | 100 percent | — | — | — |
| | Quartamin 60 W: | 30 percent | 6.67 | — | — |
| | (cationic surfactant) | | | | |
| Salt of | Magnesium sulfate | 100 percent | — | — | — |
| inorganic | hexahydrate | | | | |
| acid | Calcium nitrate | 100 percent | — | 14.39 | — |
| | tetrahydrate | | | | |
| Salt of | Ammonium lactate | 40 percent | — | — | 25.00 |
| organic | Calcium lactate | 100 percent | — | — | — |
| acid | | | | | |
| Cationic | SHALLOL ® DC-902P | 51 percent | — | — | — |
| polymer | | | | | |
| Defoaming | 2,5,8,11- | 100 percent | 0.50 | 0.50 | 0.50 |
| agent | tetramethyldodecane- | | | | |
| | 5,8-diol | | | | |
| Mildew- | Proxel GXL | 20 percent | 0.05 | 0.05 | 0.05 |
| proofing | | | | | |
| agent | | | | | |
| Corrosion | 1,2,3-benzotriazole | 100 percent | 0.10 | 0.10 | 0.10 |
| inhibitor | | | | | |
| pH | 2-amino-2-ethyl-1,3- | 97 percent | — | 0.30 | 0.30 |
| regulator | propane diol | | | | |
| Highly pure water | | | Balance | Balance | Balance |
| Total (percent by mass) | | | 100 | 100 | 100 |
| | | Concentration | | | |
| | | of solid portion | Pretreatment | Pretreatment | Pretreatment |
| Component (percent by mass) | | (percent by mass) | fluid 4 | fluid 5 | fluid 6 |
| Organic | Propylene glycol | 100 percent | 30.00 | 25.00 | 30.00 |
| solvent | 3-Methyl-1,3-butane | 100 percent | 5.00 | 5.00 | 5.00 |
| | diol | | | | |
| | Propylene glycol | 100 percent | — | — | — |
| | mono-propyl ether | | | | |
| Surfactant | SILFACE SAG503A | 100 percent | — | — | 1.50 |
| | SILFACE SAG021 | 100 percent | — | — | 0.50 |
| | TEGO ® Wet 270 | 100 percent | — | — | — |
| | BYK-3451 | 100 percent | — | 1.00 | — |
| | Capstone FS-3100 | 100 percent | 1.00 | | — |
| | Quartamin 60W: | 30 percent | — | — | — |
| | (cationic surfactant) | | | | |
| Salt of | Magnesium sulfate | 100 percent | — | — | 20.45 |
| inorganic | hexahydrate | | | | |
| acid | Calcium nitrate | 100 percent | — | — | — |
| | tetrahydrate | | | | |
| Salt of | Ammonium lactate | 40 percent | — | — | — |
| organic | Calcium lactate | 100 percent | 10.00 | — | — |
| acid | | | | | |
| Cationic | SHALLOL ® DC-902P | 51 percent | — | 19.61 | — |
| polymer | | | | | |
| Defoaming | 2,5,8,11- | 100 percent | 0.50 | 0.50 | 0.50 |
| agent | tetramethyldodecane- | | | | |
| | 5,8-diol | | | | |
| Mildew- | Proxel GXL | 20 percent | 0.05 | 0.05 | 0.05 |
| proofing | | | | | |
| agent | | | | | |
| Corrosion | 1,2,3-benzotriazole | 100 percent | 0.10 | 0.10 | 0.10 |
| inhibitor | | | | | |
| pH | 2-amino-2-ethyl-1,3- | 97 percent | 0.30 | 0.30 | 0.30 |
| regulator | propane diol | | | | |

| | | | |
|---|---|---|---|
| Highly pure water | Balance | Balance | Balance |
| Total (percent by mass) | 100 | 100 | 100 |

| | Concentration | | |
|---|---|---|---|
| | of solid portion | Pretreatment | Pretreatment |
| Component (percent by mass) | (percent by mass) | fluid 7 | fluid 8 |

| | | | | |
|---|---|---|---|---|
| Organic | Propylene glycol | 100 percent | 20.00 | 30.00 |
| solvent | 3-Methyl-1,3-butane | 100 percent | — | 5.00 |
| | diol | | | |
| | Propylene glycol | 100 percent | 10.00 | — |
| | mono-propyl ether | | | |
| Surfactant | SILFACE SAG503A | 100 percent | 1.50 | 0.50 |
| | SILFACE SAG021 | 100 percent | 0.50 | — |
| | TEGO ® Wet 270 | 100 percent | — | — |
| | BYK-3451 | 100 percent | — | — |
| | Capstone FS-3100 | 100 percent | — | — |
| | Quartamin 60W: | 30 percent | — | — |
| | (cationic surfactant) | | | |
| Salt of | Magnesium sulfate | 100 percent | 20.45 | 20.45 |
| inorganic | hexahydrate | | | |
| acid | Calcium nitrate | 100 percent | — | — |
| | tetrahydrate | | | |
| Salt of | Ammonium lactate | 40 percent | — | — |
| organic | Calcium lactate | 100 percent | — | — |
| acid | | | | |
| Cationic | SHALLOL ® DC-902P | 51 percent | — | — |
| polymer | | | | |
| Defoaming | 2,5,8,11- | 100 percent | 0.50 | 0.50 |
| agent | tetramethyldodecane- | | | |
| | 5,8-diol | | | |
| Mildew- | Proxel GXL | 20 percent | 0.05 | 0.05 |
| proofing | | | | |
| agent | | | | |
| Corrosion | 1,2,3-benzotriazole | 100 percent | 0.10 | 0.10 |
| inhibitor | | | | |
| pH | 2-amino-2-ethyl-1,3- | 97 percent | 0.30 | 0.30 |
| regulator | propane diol | | | |

| | | |
|---|---|---|
| Highly pure water | Balance | Balance |
| Total (percent by mass) | 100 | 100 |

### Properties of Pretreatment Fluid

The viscosity, dynamic surface tension, and pH of Pretreatment Liquids 1 to 8 were measured as described below.

The measuring results are shown in Table 2.

### Viscosity

The viscosity of each pretreatment liquid was measured at 25 degrees Celsius using a viscometer (RE85L, available from TOKI SANGYO CO., LTD.).

### Dynamic Surface Tension

The dynamic surface tension at 25 degrees Celsius was measured using a SITA DynoTester (available from SITA GmbH) based on the maximum bubble pressure method, at a bubble life time of 1500 msec.

pH

The pH of each pretreatment liquid was measured at 25 degrees Celsius using a pH meter (Model HM-30R, available from TOA-DKK Corporation).

TABLE 2

| | | Pretreatment | Pretreatment | Pretreatment | Pretreatment |
|---|---|---|---|---|---|
| Property | | fluid 1 | fluid 2 | fluid 3 | fluid 4 |
| Viscosity | mPa · s | 5.4 | 5.1 | 5.2 | 5.1 |
| 1,500 msec | mN/m | 21.2 | 21.6 | 20.8 | 19.8 |
| surface tension | | | | | |
| pH | | 5.6 | 9.2 | 9.2 | 9.2 |
| | | Pretreatment | Pretreatment | Pretreatment | Pretreatment |
| Property | | fluid 5 | fluid 6 | fluid 7 | fluid 8 |
| Viscosity | mPa · s | 5.1 | 5.5 | 5.8 | 4.7 |
| 1,500 msec | mN/m | 21.5 | 19.9 | 18.8 | 22.9 |
| surface tension | | | | | |
| pH | | 9.3 | 9.3 | 9.3 | 9.3 |

### Manufacturing of Aqueous Ink

Preparation of Pigment Dispersion or Liquid Dispersion of Polymer Fine Particle

### Containing Pigment

A pigment dispersion or a liquid dispersion of polymer fine particle containing a pigment was prepared according to the methods described in Preparation Examples 1 to 8 below.

### Preparation Example 1: Preparation of Surface Modified Black Pigment Dispersion

A slurry was obtained by mixing 100 g of BLACK PEARLS® 1000 (carbon black with a BET specific surface area of 343 m²/g and a dibutyl phthalate absorption (DBPA) of 105 mL/100 g, available from Cabot Corporation), 100 mmol of sulfanilic acid (available from Hayashi Pure Chemical Ind., Ltd.), and 1 L of deionized highly pure water at room temperature (23 degrees Celsius+0.5 degrees Celsius) using a Silverson® mixer (laboratory mixer, available from Silverson Nippon Limited) at 6,000 rpm.

Next, 100 mmol of nitric acid (1.42, available from Honeywell-Fluka) was added to the obtained slurry. After an additional 30 minutes, 100 mmol of sodium nitrite (available from Hayashi Pure Chemical Ind., Ltd.) dissolved in 10 mL of deionized highly pure water was slowly added. The mixture was then heated to 60 degrees Celsius with stirring and reacted for 1 hour to obtain a modified pigment in which sulfanilic acid was added to the carbon black.

Subsequently, the pH was adjusted to 9 using a 10 percent tetrabutylammonium hydroxide methanol solution (available from FUJIFILM Wako Pure Chemical Corporation), and after 30 minutes, a modified pigment dispersion was obtained.

Thereafter, ultrafiltration using a dialysis membrane was performed with the modified pigment dispersion and deionized highly pure water, followed by ultrasonic dispersion, to yield a surface-modified black pigment dispersion containing 20 percent pigment solids.

The surface treatment level of the pigment in the obtained surface-modified black pigment dispersion was 0.75 mmol/g. Measurement with a particle size distribution analyzer (NanoTrack UPA-EX150, available from Nikkiso Co., Ltd.) showed a cumulative 50 percent volume particle diameter (D50) of 120 nm.

### Preparation Example 2: Preparation of Surface Modified Magenta Pigment Dispersion

A total of 1 kg of pigment dispersion SMART Magenta 3122BA (C.I. Pigment Red 122 surface-treated dispersion, pigment solids content: 14.5 percent, available from Sensient

Technologies) was acid-precipitated using a 0.1 N aqueous hydrochloric acid solution (available from FUJIFILM Wako Pure Chemical Corporation).

Next, the pH was adjusted to 9 with a 10 percent aqueous tetraethylammonium hydroxide solution (also available from FUJIFILM Wako Pure Chemical Corporation), and after 30 minutes, a modified pigment dispersion containing a pigment bound to at least one aminobenzoic acid group or tetraethylammonium aminobenzoate was obtained.

Using the modified pigment dispersion containing a pigment bound to at least one aminobenzoic acid group or tetraethylammonium aminobenzoate and deionized highly pure water, ultrafiltration was performed through a dialysis membrane, followed by ultrasonic dispersion, to obtain a surface-modified magenta pigment dispersion containing 20 percent pigment solids.

The obtained surface-modified magenta pigment dispersion was measured using a particle size distribution analyzer (NanoTrax UPA-EX150, available from Nikkiso Co., Ltd.), and the cumulative 50 percent volume particle diameter (D50) was found to be 104 nm.

### Preparation Example 3: Preparation of Surface Modified Cyan Pigment Dispersion

A total of 1 kg of pigment dispersion SMART Magenta 3154BA (C.I. Pigment Blue 15:4, surface-treated dispersion, pigment solids content: 14.5 percent, available from Sensient Technologies) was acid-precipitated using a 0.1 N aqueous hydrochloric acid solution (available from FUJIFILM Wako Pure Chemical Corporation).

Next, the pH was adjusted to 9 with a 40 percent benzyltrimethylammonium hydroxide methanol solution (available from FUJIFILM Wako Pure Chemical Corporation), and after 30 minutes, a modified pigment dispersion containing a pigment bound to at least one aminobenzoic acid group or benzyltrimethylammonium aminobenzoate was obtained.

The thus-obtained reformed pigment dispersion including a pigment bonded to at least one amino benzoate group or amino benzoate benzyltrimethyl ammonium salt was subjected to ultrafiltering by dialysis membrane with highly deionized water, followed by ultrasonic dispersion to obtain a surface reformed cyan pigment dispersion having a pigment solid content of 20 percent by mass.

The surface reformed cyan pigment dispersion had a 50 percent cumulative volume particle diameter D50 of 116 nm as measured by a particle size distribution measuring instrument (NANOTRAC UPA-EX150, available from NIKKISO CO., LTD.).

### Preparation Example 4: Preparation of Surface Modified Yellow Pigment Dispersion

A total of 1 kg of pigment dispersion SMART Yellow 3074BA (C.I. Pigment Yellow 74 surface-treated dispersion, pigment solids content: 14.5 percent, available from Sensient Technologies) was adjusted to pH 9 with a 10 percent tetrabutylammonium hydroxide methanol solution (available from FUJIFILM Wako Pure Chemical Corporation), and after 30 minutes, a modified pigment dispersion containing a pigment bound to at least one aminobenzoic acid group or tetrabutylammonium aminobenzoate was obtained. The thus-obtained reformed pigment dispersion including a pigment bonded to at least one amino benzoate group or amino benzoate tetrabutyl ammonium salt was subjected to ultrafiltering by dialysis membrane with highly deionized water, followed by ultrasonic dispersion to obtain a surface reformed yellow pigment dispersion with a pigment solid content of 20 percent by mass.

The obtained surface-modified yellow pigment dispersion was measured using a particle size distribution analyzer (NanoTrax UPA-EX150, available from Nikkiso Co., Ltd.), and the cumulative 50 percent volume particle diameter (D50) was found to be 145 nm.

### Preparation Example 5: Preparation of Liquid Dispersion of Magenta Pigment-Containing Polymer Fine Particles

The atmosphere in a 1 L flask equipped with a mechanical stirrer, thermometer, nitrogen gas inlet tube, reflux condenser, and dropping funnel was replaced with nitrogen gas. Then 11.2 g of styrene monomer (available from FUJIFILM Wako Pure Chemical Corporation), 2.8 g of acrylic acid (available from FUJIFILM Wako Pure Chemical Corporation), 12.0 g of lauryl methacrylate (available from BASF), 4.0 g of polyethylene glycol dimethacrylate (available from Sigma-Aldrich Japan), 4.0 g of styrene macromer (available from Toagosci Co., Ltd.), and 0.4 g of mercaptoethanol (available from FUJIFILM Wako Pure Chemical Corporation) were mixed in the flask and heated to 65 degrees Celsius. Next, a liquid mixture of 100.8 g of styrene, 25.2 g of acrylic acid, 108.0 g of lauryl methacrylate, 36.0 g of polyethylene glycol dimethacrylate, 60.0 g of hydroxyethyl methacrylate (available from Nippon Shokubai Co., Ltd.), 36.0 g of styrene macromer, 3.6 g of mercaptoethanol, 2.4 g of 2,2′-azobis(2,4-dimethylvaleronitrile) (95 percent, available from FUJIFILM Wako Pure Chemical Corporation), and 18 g of methyl ethyl ketone (available from FUJIFILM Wako Pure Chemical Corporation) was added dropwise to the flask over 2.5 hours.

After the dropwise addition, a liquid mixture of 0.8 g of 2,2′-azobis(2,4-dimethylvaleronitrile) (95 percent, available from FUJIFILM Wako Pure Chemical Corporation) and 18 g of methyl ethyl ketone was added dropwise to the flask over 0.5 hours. The mixture was stirred at 65 degrees Celsius for 1 hour, after which 0.8 g of 2,2′-azobis(2,4-dimethylvaleronitrile) was added and stirring was continued for another hour. After completion of the reaction, 364 g of methyl ethyl ketone was added to the flask, yielding 800 g of a polymer solution A with a concentration of 50 percent.

Next, 28 g of polymer solution A, 42 g of C.I. Pigment Red 122 (available from BASF), 13.6 g of a 1 mol/L aqueous potassium hydroxide solution (available from FUJIFILM Wako Pure Chemical Corporation), 20 g of methyl ethyl ketone, and 13.6 g of deionized water were stirred thoroughly and then kneaded using a roll mill. The resulting paste (approximately 117 g) was added to 200 g of pure water and stirred thoroughly, after which methyl ethyl ketone and water were distilled off using an evaporator. To remove coarse particles, the liquid dispersion was pressure-filtered through a polyvinylidene fluoride membrane filter with an average pore size of 5.0 μm (available from Sigma-Aldrich Japan), yielding a liquid dispersion of a magenta pigment-containing polymer fine particles containing 15 percent pigment solids and 20 percent total solids.

The obtained liquid dispersion of magenta pigment-containing polymer fine particles was measured using a particle size distribution analyzer (NanoTrax UPA-EX150, available from Nikkiso Co., Ltd.), and the cumulative 50 percent volume particle diameter (D50) was found to be 127 nm.

### Preparation Example 6: Preparation of Liquid Dispersion of Cyan Pigment-Containing Polymer Fine Particles

A liquid dispersion of a cyan pigment-containing polymer fine particles containing 15 percent pigment solids and 20 percent total solids was prepared in the same manner as in Preparation Example 5 except that C.I. Pigment Red 122 as pigment was changed to a phthalocyanine pigment (C.I. Pigment Blue 15:3, available from Dainichiscika Color & Chemicals Mfg. Co., Ltd.).

The cumulative average particle diameter D50 of the polymer fine particle in the liquid dispersion of cyan pigment-containing polymer fine particles obtained was 93 nm as measured with a particle size distribution measuring instrument (NANOTRAC UPA-EX150, available from NIKKISO CO., LTD.).

### Preparation Example 7: Preparation of Liquid Dispersion of Yellow Pigment-Containing Polymer Fine Particles

A liquid dispersion of a yellow pigment-containing polymer fine particles containing 15 percent pigment solids and 20 percent total solids was prepared in the same manner as in Preparation Example 5 except that C.I. Pigment Red 122 as pigment was changed to bisazo yellow pigment (C.I. Pigment Blue 155, available from DIC Corporation).

The cumulative average particle diameter D₅₀ of the polymer fine particle in the liquid dispersion of yellow pigment-containing polymer fine particles obtained was 76 nm as measured with a particle size distribution measuring instrument (NANOTRAC UPA-EX150, available from NIKKISO CO., LTD.).

### Preparation Example 8: Preparation of Liquid Dispersion of Black Pigment-Containing Polymer Fine Particles

A liquid dispersion of a black pigment-containing polymer fine particles containing 15 percent pigment solids and 20 percent total solids was prepared in the same manner as in Preparation Example 5 except that C.I. Pigment Red 122 as pigment was changed to carbon black (FW100, available from Degussa AG).

The cumulative average particle diameter D50 of the polymer fine particle in the liquid dispersion of black pigment-containing polymer fine particles obtained was 104 nm as measured with a particle size distribution measuring instrument (NANOTRAC UPA-EX150, available from NIKKISO CO., LTD.).

### Manufacturing of Aqueous Ink

Color inks as aqueous inks were produced according to the methods described for Aqueous Inks 1 to 9.

### Manufacturing of Aqueous Ink 1

Into a container equipped with a stirrer, 0.20 parts of 2-amino-2-ethyl-1,3-propanediol (97 percent, available from FUJIFILM Wako Pure Chemical Corporation), 0.50 parts of 2,4,7,9-tetramethyl-5-decyne-4,7-diol, 3.00 parts of 2-ethyl-1,3-hexanediol (available from FUJIFILM Wako Pure Chemical Corporation), 30.00 parts of propylene glycol (available from FUJIFILM Wako Pure Chemical Corporation), 1.20 parts of TEGO® Wet 270 (available from Evonik Japan Co., Ltd.), and 1.60 parts of SILFACE SAG 503A (available from Nissin Chemical Industry Co., Ltd.) were added and mixed with stirring for 15 minutes. Next, 0.05 parts of the preservative and antifungal agent PROXEL® GXL and 20.00 parts of the surface-modified black pigment dispersion of Preparation Example 1 were added, followed by mixing and stirring for 20 minutes. Then 22.37 parts of Superflex 460 as resin particles and a sufficient amount of highly pure water to bring the total to 100 parts were added and mixed with stirring for 15 minutes. The resulting mixture was pressure-filtered through a polyvinylidene fluoride membrane filter having an average pore diameter of 5.0 μm to remove coarse particles and debris, thereby obtaining Aqueous Ink 1.

### Manufacturing of Aqueous Inks 2 to 9

Aqueous Inks 2 to 9 were manufactured in the same manner as in the Manufacturing of Aqueous Ink 1, except that the ink formulations were changed to the materials and contents shown in Table 3 below.

The content of each material is represented in percent by mass in Table 3 below. It does not represent the content of solid portion or active ingredient but all included.

The details of the various materials shown in Table 3 are as follows.

### Resin Particles

Superflex 460: Polyurethane dispersion, Tg: −21 degrees Celsius, volume average particle diameter: 40 nm, solid content: 38 percent, available from DKS Co. Ltd.
Superflex 150: Polyurethane dispersion, Tg: 40 degrees Celsius, volume average particle diameter: 30 nm, solid content: 30 percent, available from DKS Co. Ltd.
TOCRYL BCX-8111: Acrylic resin emulsion, Tg:−30 degrees Celsius, volume average particle diameter: 90 nm, solid content: 58 percent, available from TOYOCHEM Co., Ltd.
TOCRYL W-168: Acrylic resin emulsion, Tg:−10 degrees Celsius, volume average particle diameter: 100 nm, solid content: 49.5 percent, available from TOYOCHEM Co., Ltd.
HI-LOUS PE-1126: Acrylic resin emulsion, Tg:−12 degrees Celsius, volume average particle diameter: 60 nm, solid content: 41.5 percent, available from SEIKO PMC Corporation
HI-LOUS JE-1056: Acrylic resin emulsion, Tg: 82 degrees Celsius, volume average particle diameter: 50 nm, solid content: 42.5 percent, available from SEIKO PMC Corporation
HI-LOUS KE-1062: Acrylic resin emulsion, Tg: 96 degrees Celsius, volume average particle diameter: 80 nm, solid content: 43.0 percent, available from SEIKO PMC Corporation

### Organic Solvent

Propylene glycol (available from Tokyo Chemical Industry Co., Ltd.)
Propylene glycol monopropyl ether (available from Tokyo Chemical Industry Co., Ltd.)
3-Methyl-1,3-butanediol (available from Tokyo Chemical Industry Co., Ltd.)
1,2-Butanediol (available from Tokyo Chemical Industry Co., Ltd.)
1,2-Hexanediol (available from FUJIFILM Wako Pure Chemical Corporation)
2-Ethyl-1,3-hexanediol (available from Tokyo Chemical Industry Co., Ltd.)

### Surfactant

TEGO® Wet 270: Polyether-modified siloxane compound, available from Evonik Japan Co., Ltd., active ingredient content: 100 percent
SILFACE SAG503A: Polyether-modified siloxane compound, available from Nissin Chemical Industry Co., Ltd., active ingredient content: 100 percent
SILFACE SAG021: Polyether-modified siloxane compound, available from Nissin Chemical Industry Co., Ltd., active ingredient content: 100 percent
ORPHIN EXP.4200: Acetylenic glycol ethylene oxide adduct, available from Nissin Chemical Industry Co., Ltd., active ingredient content: 100 percent
UNIDYNE DSN-403N: Perfluoroalkyl polyethylene oxide adduct, available from Daikin Industries, Ltd., active ingredient content: 75 percent

### Preservative and Antifungal Agent

PROXEL® GXL: Preservative and antifungal agent mainly composed of 1,2-benzisothiazolin-3-one (available from Nitto Denko Avecia), active ingredient content: 20 percent, containing dipropylene glycol Defoaming Agent
2,4,7,9-Tetramethyldecane-4,7-diol
2,5,8,11-Tetramethyldodecane-5,8-diol

### pH Regulator

2-Amino-2-ethyl-1,3-propanediol (available from FUJIFILM Wako Pure Chemical Corporation)

TABLE 3

| | | Active | | Aqueous | Aqueous | Aqueous |
|---|---|---|---|---|---|---|
| Component (percent by mass) | | ingredient | | ink 1 | ink 2 | ink 3 |
| Coloring | Surface-modified black | 20.0 | percent | 20.00 | — | — |
| material | pigment dispersion, | | | | | |
| (pigment | (Preparation Example 1, | | | | | |
| dispersion) | pigment solid content of 20 | | | | | |
| | percent by mass) | | | | | |
| | Surface-modified magenta | 20.0 | percent | — | 20.00 | — |
| | pigment dispersion, | | | | | |
| | (Preparation Example 2, | | | | | |
| | pigment solid content of 20 | | | | | |
| | percent by mass) | | | | | |
| | Surface-modified cyan | 20.0 | percent | — | — | 12.50 |
| | pigment dispersion, | | | | | |
| | (Preparation Example 3, | | | | | |
| | pigment solid content of 20 | | | | | |
| | percent by mass) | | | | | |
| | Surface-modified yellow | 20.0 | percent | — | — | — |
| | pigment dispersion, | | | | | |
| | (Preparation Example 4, | | | | | |
| | pigment solid content of 20 | | | | | |
| | percent by mass) | | | | | |
| | Liquid dispersion of fine | 15.0 | percent | — | — | — |
| | polymer particle containing | | | | | |
| | magenta pigment | | | | | |
| | (Preparation Example 5, | | | | | |
| | pigment solid content of 15 | | | | | |
| | percent by mass) | | | | | |
| | Liquid dispersion of fine | 15.0 | percent | — | — | — |
| | polymer particle containing | | | | | |
| | cyan pigment | | | | | |
| | (Preparation Example 6, | | | | | |
| | pigment solid content of 15 | | | | | |
| | percent by mass) | | | | | |
| | Liquid dispersion of fine | 15.0 | percent | — | — | — |
| | polymer particle containing | | | | | |
| | yellow pigment | | | | | |
| | (Preparation Example 7, | | | | | |
| | pigment solid content of 15 | | | | | |
| | percent by mass) | | | | | |
| | Liquid dispersion of fine | 15.0 | percent | — | — | — |
| | polymer particle containing | | | | | |
| | carbon pigment | | | | | |
| | (Preparation Example 8, | | | | | |
| | pigment solid content of 15 | | | | | |
| | percent by mass) | | | | | |
| Resin | SUPERFLEX ® 460 (Tg: −21 | 38.0 | percent | 22.37 | — | — |
| particle | degrees Celsius, volume | | | | | |
| | average particle diameter: | | | | | |
| | 40 nm | | | | | |
| | SUPERFLEX ® 150 (Tg: 40 | 30.0 | percent | — | — | 28.33 |
| | degrees Celsius, volume | | | | | |
| | average particle diameter: | | | | | |
| | 30 nm | | | | | |
| | TOCRYL BCX-8111 (Tg: −30 | 58.0 | percent | — | — | — |
| | degrees Celsius, volume | | | | | |
| | average particle diameter: | | | | | |
| | 90 nm | | | | | |
| | TOCRYL W-168 (Tg: −10 | 49.5 | percent | — | 17.17 | — |
| | degrees Celsius, volume | | | | | |
| | average particle diameter: | | | | | |
| | 100 nm | | | | | |
| | HI-LOUS-X PE-1126 (Tg: −12 | 41.5 | percent | — | — | — |
| | degrees Celsius, volume | | | | | |
| | average particle diameter: | | | | | |
| | 60 nm | | | | | |
| | HI-LOUS-X JE-1056 (Tg: 82 | 42.5 | percent | — | — | — |
| | degrees Celsius, volume | | | | | |
| | average particle diameter: | | | | | |
| | 50 nm | | | | | |
| | HI-LOUS-X KE-1062 (Tg: 96 | 43.0 | percent | — | — | — |
| | degrees Celsius, volume | | | | | |
| | average particle diameter: | | | | | |
| | 80 nm | | | | | |
| Organic | Propylene glycol | 100 | percent | 30.00 | 20.00 | 16.67 |
| solvent | Propylene glycol mono- | 100 | percent | — | 5.00 | 8.33 |
| | propyl ether | | | | | |
| | 3-methyl-1,3-butane diol | 100 | percent | — | — | — |
| | 1,2-butanediol | 100 | percent | — | — | — |
| | 1,2-hexane diol | 100 | percent | — | — | — |
| | 2-ethyl-1,3-hexanediol | 100 | percent | 3.00 | 3.00 | 3.00 |
| Surfactant | TEGO ® Wet 270 | 100 | percent | 1.20 | 1.20 | 1.50 |
| | UNIDYNE ™ DSN-403N | 100 | percent | — | — | — |
| | SILFACE SAG021 | 100 | percent | — | — | — |
| | SILFACE SAG503A | 100 | percent | 1.60 | 1.60 | 2.00 |
| | OLFINE ® EXP.4200 | 75 | percent | — | — | — |
| Mildew- | Proxel GXL | 20.0 | percent | 0.05 | 0.05 | 0.05 |
| proofing | | | | | | |
| agent | | | | | | |
| Foam | 2,4,7,9-tetramethyldecane- | 100 | percent | 0.50 | 0.50 | 0.30 |
| inhibitor | 4,7-diol | | | | | |
| (defoaming | 2,5,8,11-tetramethyldodecane- | 100 | percent | — | — | — |
| agent) | 5,8-diol | | | | | |
| pH | 2-amino-2-ethyl-1,3- | 100 | percent | 0.20 | 0.20 | 0.20 |
| regulator | propane diol | | | | | |
| Pure water | | | | Balance | Balance | Balance |
| Total (percent by mass) | | | | 100 | 100 | 100 |
| | | Active | | Aqueous | Aqueous | Aqueous |
| Component (percent by mass) | | ingredient | | ink 4 | ink 5 | ink 6 |
| Coloring | Surface-modified black | 20.0 | percent | — | — | — |
| material | pigment dispersion, | | | | | |
| (pigment | (Preparation Example 1, | | | | | |
| dispersion) | pigment solid content of 20 | | | | | |
| | percent by mass) | | | | | |
| | Surface-modified magenta | 20.0 | percent | — | — | — |
| | pigment dispersion, | | | | | |
| | (Preparation Example 2, | | | | | |
| | pigment solid content of 20 | | | | | |
| | percent by mass) | | | | | |
| | Surface-modified cyan | 20.0 | percent | — | — | — |
| | pigment dispersion, | | | | | |
| | (Preparation Example 3, | | | | | |
| | pigment solid content of 20 | | | | | |
| | percent by mass) | | | | | |
| | Surface-modified yellow | 20.0 | percent | 12.50 | — | — |
| | pigment dispersion, | | | | | |
| | (Preparation Example 4, | | | | | |
| | pigment solid content of 20 | | | | | |
| | percent by mass) | | | | | |
| | Liquid dispersion of fine | 15.0 | percent | — | 26.67 | — |
| | polymer particle containing | | | | | |
| | magenta pigment | | | | | |
| | (Preparation Example 5, | | | | | |
| | pigment solid content of 15 | | | | | |
| | percent by mass) | | | | | |
| | Liquid dispersion of fine | 15.0 | percent | — | — | 20.00 |
| | polymer particle containing | | | | | |
| | cyan pigment | | | | | |
| | (Preparation Example 6, | | | | | |
| | pigment solid content of 15 | | | | | |
| | percent by mass) | | | | | |
| | Liquid dispersion of fine | 15.0 | percent | — | — | — |
| | polymer particle containing | | | | | |
| | yellow pigment | | | | | |
| | (Preparation Example 7, | | | | | |
| | pigment solid content of 15 | | | | | |
| | percent by mass) | | | | | |
| | Liquid dispersion of fine | 15.0 | percent | — | — | — |
| | polymer particle containing | | | | | |
| | carbon pigment | | | | | |
| | (Preparation Example 8, | | | | | |
| | pigment solid content of 15 | | | | | |
| | percent by mass) | | | | | |
| Resin | SUPERFLEX ® 460 (Tg: −21 | 38.0 | percent | — | — | — |
| particle | degrees Celsius, volume | | | | | |
| | average particle diameter: | | | | | |
| | 40 nm | | | | | |
| | SUPERFLEX ® 150 (Tg: 40 | 30.0 | percent | — | — | — |
| | degrees Celsius, volume | | | | | |
| | average particle diameter: | | | | | |
| | 30 nm | | | | | |
| | TOCRYL BCX-8111 (Tg: −30 | 58.0 | percent | — | — | — |
| | degrees Celsius, volume | | | | | |
| | average particle diameter: | | | | | |
| | 90 nm | | | | | |
| | TOCRYL W-168 (Tg: −10 | 49.5 | percent | — | — | — |
| | degrees Celsius, volume | | | | | |
| | average particle diameter: | | | | | |
| | 100 nm | | | | | |
| | HI-LOUS-X PE-1126 (Tg: −12 | 41.5 | percent | — | — | — |
| | degrees Celsius, volume | | | | | |
| | average particle diameter: | | | | | |
| | 60 nm | | | | | |
| | HI-LOUS-X JE-1056 (Tg: 82 | 42.5 | percent | 33.33 | — | 20.00 |
| | degrees Celsius, volume | | | | | |
| | average particle diameter: | | | | | |
| | 50 nm | | | | | |
| | HI-LOUS-X KE-1062 (Tg: 96 | 43.0 | percent | — | 17.44 | — |
| | degrees Celsius, volume | | | | | |
| | average particle diameter: | | | | | |
| | 80 nm | | | | | |
| Organic | Propylene glycol | 100 | percent | 25.00 | 16.67 | 16.67 |
| solvent | Propylene glycol mono- | 100 | percent | — | 8.33 | 8.33 |
| | propyl ether | | | | | |
| | 3-methyl-1,3-butane diol | 100 | percent | — | — | — |
| | 1,2-butanediol | 100 | percent | — | — | — |
| | 1,2-hexane diol | 100 | percent | — | 3.00 | — |
| | 2-ethyl-1,3-hexanediol | 100 | percent | 3.00 | — | 3.00 |
| Surfactant | TEGO ® Wet 270 | 100 | percent | — | — | — |
| | UNIDYNE ™ DSN-403N | 100 | percent | 1.00 | — | — |
| | SILFACE SAG021 | 100 | percent | — | 0.50 | 0.50 |
| | SILFACE SAG503A | 100 | percent | — | 1.50 | 1.50 |
| | OLFINE ® EXP.4200 | 75 | percent | — | — | — |
| Mildew- | Proxel GXL | 20.0 | percent | 0.05 | 0.05 | 0.05 |
| proofing | | | | | | |
| agent | | | | | | |
| Foam | 2,4,7,9-tetramethyldecane- | 100 | percent | 0.30 | — | — |
| inhibitor | 4,7-diol | | | | | |
| (defoaming | 2,5,8,11-tetramethyldodecane- | 100 | percent | — | 0.20 | 0.20 |
| agent) | 5,8-diol | | | | | |
| pH regulator | 2-amino-2-ethyl-1,3- | 100 | percent | 0.20 | 0.30 | 0.30 |
| | propane diol | | | | | |
| Pure water | | | | Balance | Balance | Balance |
| Total (percent by mass) | | | | 100 | 100 | 100 |
| | | Active | | Aqueous | Aqueous | Aqueous |
| Component (percent by mass) | | ingredient | | ink 7 | ink 8 | ink 9 |
| Coloring | Surface-modified black | 20.0 | percent | — | — | — |
| material | pigment dispersion, | | | | | |
| (pigment | (Preparation Example 1, | | | | | |
| dispersion) | pigment solid content of 20 | | | | | |
| | percent by mass) | | | | | |
| | Surface-modified magenta | 20.0 | percent | — | — | — |
| | pigment dispersion, | | | | | |
| | (Preparation Example 2, | | | | | |
| | pigment solid content of 20 | | | | | |
| | percent by mass) | | | | | |
| | Surface-modified cyan | 20.0 | percent | — | — | — |
| | pigment dispersion, | | | | | |
| | (Preparation Example 3, | | | | | |
| | pigment solid content of 20 | | | | | |
| | percent by mass) | | | | | |
| | Surface-modified yellow | 20.0 | percent | — | — | — |
| | pigment dispersion, | | | | | |
| | (Preparation Example 4, | | | | | |
| | pigment solid content of 20 | | | | | |
| | percent by mass) | | | | | |
| | Liquid dispersion of fine | 15.0 | percent | — | — | — |
| | polymer particle containing | | | | | |
| | magenta pigment | | | | | |
| | (Preparation Example 5, | | | | | |
| | pigment solid content of 15 | | | | | |
| | percent by mass) | | | | | |
| | Liquid dispersion of fine | 15.0 | percent | — | — | 20.00 |
| | polymer particle containing | | | | | |
| | cyan pigment | | | | | |
| | (Preparation Example 6, | | | | | |
| | pigment solid content of 15 | | | | | |
| | percent by mass) | | | | | |
| | Liquid dispersion of fine | 15.0 | percent | 20.00 | — | — |
| | polymer particle containing | | | | | |
| | yellow pigment | | | | | |
| | (Preparation Example 7, | | | | | |
| | pigment solid content of 15 | | | | | |
| | percent by mass) | | | | | |
| | Liquid dispersion of fine | 15.0 | percent | — | 26.67 | — |
| | polymer particle containing | | | | | |
| | carbon pigment | | | | | |
| | (Preparation Example 8, | | | | | |
| | pigment solid content of 15 | | | | | |
| | percent by mass) | | | | | |
| Resin | SUPERFLEX ® 460 (Tg: −21 | 38.0 | percent | — | — | — |
| particle | degrees Celsius, volume | | | | | |
| | average particle diameter: | | | | | |
| | 40 nm | | | | | |
| | SUPERFLEX ® 150 (Tg: 40 | 30.0 | percent | — | — | — |
| | degrees Celsius, volume | | | | | |
| | average particle diameter: | | | | | |
| | 30 nm | | | | | |
| | TOCRYL BCX-8111 (Tg: −30 | 58.0 | percent | 13.79 | — | — |
| | degrees Celsius, volume | | | | | |
| | average particle diameter: | | | | | |
| | 90 nm | | | | | |
| | TOCRYL W-168 (Tg: −10 | 49.5 | percent | — | — | — |
| | degrees Celsius, volume | | | | | |
| | average particle diameter: | | | | | |
| | 100 nm | | | | | |
| | HI-LOUS-X PE-1126 (Tg: −12 | 41.5 | percent | — | 16.87 | — |
| | degrees Celsius, volume | | | | | |
| | average particle diameter: | | | | | |
| | 60 nm | | | | | |
| | HI-LOUS-X JE-1056 (Tg: 82 | 42.5 | percent | — | — | 20.00 |
| | degrees Celsius, volume | | | | | |
| | average particle diameter: | | | | | |
| | 50 nm | | | | | |
| | HI-LOUS-X KE-1062 (Tg: 96 | 43.0 | percent | — | 17.14 | — |
| | degrees Celsius, volume | | | | | |
| | average particle diameter: | | | | | |
| | 80 nm | | | | | |
| Organic | Propylene glycol | 100 | percent | 10.00 | 12.50 | 16.67 |
| solvent | Propylene glycol mono- | 100 | percent | 10.00 | 12.50 | 8.33 |
| | propyl ether | | | | | |
| | 3-methyl-1,3-butane diol | 100 | percent | — | 3.00 | — |
| | 1,2-butanediol | 100 | percent | 2.00 | — | — |
| | 1,2-hexane diol | 100 | percent | — | — | — |
| | 2-ethyl-1,3-hexanediol | 100 | percent | 1.00 | 1.00 | — |
| Surfactant | TEGO ® Wet 270 | 100 | percent | — | — | — |
| | UNIDYNE ™ DSN-403N | 100 | percent | — | — | — |
| | SILFACE SAG021 | 100 | percent | 0.30 | 0.60 | — |
| | SILFACE SAG503A | 100 | percent | 2.70 | 2.40 | — |
| | OLFINE ® EXP.4200 | 75 | percent | — | — | 1.33 |
| Mildew- | Proxel GXL | 20.0 | percent | 0.05 | 0.05 | 0.05 |
| proofing | | | | | | |
| agent | | | | | | |
| Foam | 2,4,7,9-tetramethyldecane- | 100 | percent | — | — | — |
| inhibitor | 4,7-diol | | | | | |
| (defoaming | 2,5,8,11-tetramethyldodecane- | 100 | percent | 0.20 | 0.20 | 0.20 |
| agent) | 5,8-diol | | | | | |
| pH regulator | 2-amino-2-ethyl-1,3- | 100 | percent | 0.30 | 0.30 | 0.30 |
| | propane diol | | | | | |

| | | | |
|---|---|---|---|
| Pure water | Balance | Balance | Balance |
| Total (percent by mass) | 100 | 100 | 100 |

### Aqueous Ink Properties

For Aqueous Inks 1 to 9, viscosity, dynamic surface tension, and pH were measured as described below. The measuring results are shown in Table 4.

### Viscosity

The viscosity of Aqueous Inks 1 to 9 was measured at 25 degrees Celsius using a viscometer (RE85L, available from TOKISANGYO Co., Ltd.).

### Dynamic Surface Tension

The dynamic surface tension of the aqueous inks at 25 degrees Celsius was measured using the maximum bubble pressure method at a surface life time (bubble life time) of 1500 msec with a SITA DynoTester (available from SITA GmbH). pH

The pH of Aqueous Inks 1 to 9 was measured at 25 degrees Celsius using a pH meter (Model HM-30R, available from TOA-DKK Corporation).

TABLE 4

| | | Aqueous | Aqueous | Aqueous | Aqueous | Aqueous |
|---|---|---|---|---|---|---|
| Property | | ink 1 | ink 2 | ink 3 | ink 4 | ink 5 |
| Viscosity | mPa · s | 13.1 | 10.5 | 9.5 | 6.56 | 9.4 |
| 1,500 msec | mN/m | 21.1 | 21.7 | 21.9 | 19.0 | 20.5 |
| surface tension | | | | | | |
| pH | | 8.2 | 7.9 | 8.3 | 8.2 | 8.9 |

| | | Aqueous | Aqueous | Aqueous | Aqueous |
|---|---|---|---|---|---|
| Property | | ink 6 | ink 7 | ink 8 | ink 9 |
| Viscosity | mPa · s | 9.2 | 7.3 | 8.6 | 8.2 |
| 1,500 msec | mN/m | 20.4 | 19.9 | 20.2 | 28.5 |
| surface tension | | | | | |
| pH | | 8.8 | 8.9 | 9.0 | 9.1 |

### Examples 1 to 14 and Comparative Examples 1 to 5

Image formation was carried out using the method described below.

In an environment in which the temperature and moisture were controlled at 23±0.5 degrees Celsius and 50±5 percent RH, an inkjet printer, Garment Printer RICOH Ri 100, available from RICOH CO., LTD., was used to attach the same amount of ink to a target object by changing the drive voltage of piezoelectric element.

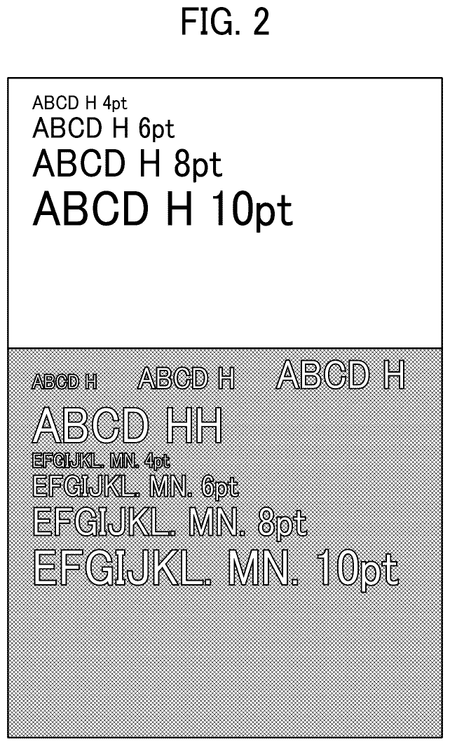

First, as shown in Table 5 below, a pretreatment liquid was discharged onto a predetermined intermediate transfer body using a predetermined discharge method, in an amount to achieve a predetermined application quantity. Subsequently, the predetermined aqueous ink (color ink) shown in Table 5 was continuously discharged at the predetermined application quantity onto the region where the pretreatment liquid and aqueous ink had been applied. As a result, the chart shown in FIG. 2 was printed at 600 dpi×600 dpi.

Then drying was appropriately carried out in an oven (post-drying), and the intermediate transfer body having the formed intermediate image was brought into contact with a predetermined recording medium. Heat transfer was conducted using a contact heat fixing device mounted on the RICOH Pro C9500. As a result, the image was formed on the recording medium.

The details of the intermediate transfer bodies shown in Table 5 are as follows:
Intermediate Transfer Body 1: Ethylene-propylene rubber sheet (EPDM), 1 mm thick, available from Kureha Elastomer Co., Ltd., Product No.: EB270NE
Intermediate Transfer Body 2: Silicone rubber, 1 mm thick, available from Kureha Elastomer Co., Ltd., Product No.: SW950D
Intermediate Transfer Body 3: Silicone rubber, 1 mm thick, available from Kureha Elastomer Co., Ltd., Product No.: SW970D
Intermediate Transfer Body 4: Fluororubber, 1 mm thick, available from Kureha Elastomer Co., Ltd., Product No.: FB780N

The details of the various recording media shown in Table 5 are as follows:
Recording Medium 1: Coated printing paper (OK Topcoat+, 128 g/m², available from Oji Paper Co., Ltd.)
Recording Medium 2: Plain printing paper (OK Prince Fine, 64 g/m², available from Oji Paper Co., Ltd.)

### Evaluation

Each image obtained in Examples 1 to 14 and Comparative Examples 1 to 5 was evaluated as described below. The results are shown in Table 6.

### Contact Angle

At 25 degrees Celsius, each ink listed in Table 3 was dispensed at 2.0 uL from a syringe fitted with a needle having an inner diameter of 0.37 μm and 0.18 mm. The contact angle was measured 1.5 seconds after droplet placement using a curve fitting method. The contact angle at 25 degrees Celsius was measured using an automatic contact angle meter, DMo-501 (available from Kyowa Interface Science Co., Ltd.).

### Transfer Density

The solid image area after transfer was measured for density using the X-Rite exact (available from X-Rite, Inc.). The evaluation criteria were as follows:

Evaluation Criteria for Coated Printing Paper
A: Black≥2.0, Cyan≥2.0, Magenta≥1.8, Yellow≥1.3
B: 1.8≤Black<2.0, 1.8≤Cyan<2.0, 1.6≤Magenta <1.8, 1.2≤Yellow<1.3
C: 1.6≤Black <1.8, 1.6<Cyan <1.8, 1.4≤Magenta <1.6, 1.1≤Yellow<1.2
D: Black <1.6, Cyan <1.6, Magenta <1.4, Yellow <1.1

### Evaluation Criteria for Plain Printing Paper

A: Black ≥1.6, Cyan ≥1.6, Magenta ≥1.1, Yellow ≥0.9
B: 1.4<Black <1.6, 1.4≤Cyan <1.6, 1.0≤Magenta <1.1, 0.85≤Yellow <0.9
C: 1.2<Black <1.4, 1.2≤Cyan <1.4, 0.9≤Magenta <1.0, 0.8≤Yellow<0.85
D: Black <1.2, Cyan <1.2, Magenta <0.9, Yellow <0.8

### Text Sharpness

The sharpness of transferred printed text was visually evaluated. The evaluation criteria were as follows:

### Evaluation Criteria

A: 4-pt text is legible
B: 6-pt text is legible
C: 8-pt text is legible
D: 8-pt text is blurred or unclear

### Beading

Beading (density unevenness) in the solid image area after transfer was visually observed and rated according to the following evaluation criteria:

### Evaluation Criteria

A: No visible density unevenness
B: Slight density unevenness
C: Noticeable density unevenness
D: Severe density unevenness

TABLE 5

| | Intermediate transfer body | | | |
|---|---|---|---|---|
| | | | Rubber | |
| | Product | | hardness | Rubber |
| | name | Material | (Shore A) | thickness |
| Example 1 | EB270NE | EPDM | 70 | 1 mm |
| Example 2 | EB270NE | EPDM | 70 | 1 mm |
| Example 3 | SW950D | Silicone | 50 | 1 mm |
| | | rubber | | |
| Example 4 | FB780N | Fluorine | 80 | 1 mm |
| | | rubber | | |
| Example 5 | SW970D | Silicone | 70 | 1 mm |
| | | rubber | | |
| Example 6 | SW970D | Silicone | 70 | 1 mm |
| | | rubber | | |
| Example 7 | SW970D | Silicone | 70 | 1 mm |
| | | rubber | | |
| Example 8 | SW970D | Silicone | 70 | 1 mm |
| | | rubber | | |
| Example 9 | FB780N | Fluorine | 80 | 1 mm |
| | | rubber | | |
| Example 10 | SW970D | Silicone | 70 | 1 mm |
| | | rubber | | |
| Example 11 | SW970D | Silicone | 70 | 1 mm |
| | | rubber | | |
| Example 12 | SW970D | Silicone | 70 | 1 mm |
| | | rubber | | |
| Example 13 | SW970D | Silicone | 70 | 1 mm |
| | | rubber | | |
| Example 14 | SW970D | Silicone | 70 | 1 mm |
| | | rubber | | |
| Comparative | EB270NE | EPDM | 70 | 1 mm |
| Example 1 | | | | |
| Comparative | SW970D | Silicone | 70 | 1 mm |
| Example 2 | | rubber | | |
| Comparative | SW970D | Silicone | 70 | 1 mm |
| Example 3 | | rubber | | |
| Comparative | SW970D | Silicone | 70 | 1 mm |
| Example 4 | | rubber | | |
| Comparative | SW970D | Silicone | 70 | 1 mm |
| Example 5 | | rubber | | |

| | Pretreatment fluid | | | |
|---|---|---|---|---|
| | | | | Bubble life |
| | | | | time: 1500 msec |
| | | Amount | Contact | Surface |
| | | attached | Angle | tension |
| | | g/m | Degree | (mN/m) |
| Example 1 | Pretreatment | 2 | 33 | 21.2 |
| | fluid 1 | | | |
| Example 2 | Pretreatment | 2 | 34 | 21.6 |
| | fluid 2 | | | |
| Example 3 | Pretreatment | 1 | 32 | 20.8 |
| | fluid 3 | | | |
| Example 4 | Pretreatment | 1 | 30 | 19.8 |
| | fluid 4 | | | |
| Example 5 | Pretreatment | 1 | 33 | 21.5 |
| | fluid 5 | | | |
| Example 6 | Pretreatment | 1 | 24 | 19.9 |
| | fluid 6 | | | |
| Example 7 | Pretreatment | 1 | 22 | 18.8 |
| | fluid 7 | | | |
| Example 8 | Pretreatment | 1 | 22 | 18.8 |
| | fluid 7 | | | |
| Example 9 | Pretreatment | 2 | 39 | 18.8 |
| | fluid 7 | | | |
| Example 10 | Pretreatment | 1 | 33 | 21.5 |
| | fluid 5 | | | |
| Example 11 | Pretreatment | 1 | 24 | 19.9 |
| | fluid 6 | | | |
| Example 12 | Pretreatment | 1 | 22 | 18.8 |
| | fluid 7 | | | |
| Example 13 | Pretreatment | 1 | 22 | 18.8 |
| | fluid 7 | | | |
| Example 14 | Pretreatment | 1 | 22 | 18.8 |
| | fluid 7 | | | |
| Comparative | — | — | — | — |
| Example 1 | | | | |
| Comparative | — | — | — | — |
| Example 2 | | | | |
| Comparative | Pretreatment | 2 | 42 | 22.9 |
| Example 3 | fluid 8 | | | |
| Comparative | Pretreatment | 1 | 22 | 18.8 |
| Example 4 | fluid 7 | | | |
| Comparative | Pretreatment | 2 | 42 | 22.9 |
| Example 5 | fluid 8 | | | |

| | Aqueous ink | | | | | |
|---|---|---|---|---|---|---|
| | | | | Bubble | | |
| | | | | life time: | | |
| | | | | 1500 msec | | |
| | | Amount | Contact | Surface | | Transfer |
| | | attached | angle | tension | Dry | recording |
| | | g/m | Degree | (mN/m) | condition | medium |
| Example 1 | Aqueous | 9.8 | 36 | 21.1 | 120 | OK |
| | ink 1 | | | | degrees | TopKote+ |
| | | | | | Celsius | |
| | | | | | for three | |
| | | | | | minutes | |
| Example 2 | Aqueous | 9.8 | 37 | 21.7 | 120 | OK |
| | ink 2 | | | | degrees | TopKote+ |
| | | | | | Celsius | |
| | | | | | for three | |
| | | | | | minutes | |
| Example 3 | Aqueous | 9.8 | 39 | 21.9 | 120 | OK |
| | ink 3 | | | | degrees | TopKote+ |
| | | | | | Celsius | |
| | | | | | for three | |
| | | | | | minutes | |
| Example 4 | Aqueous | 9.5 | 29 | 19.0 | 120 | OK |
| | ink 4 | | | | degrees | TopKote+ |
| | | | | | Celsius | |
| | | | | | for three | |
| | | | | | minutes | |
| Example 5 | Aqueous | 9.6 | 28 | 20.5 | 120 | OK |
| | ink 5 | | | | degrees | TopKote+ |
| | | | | | Celsius | |
| | | | | | for three | |
| | | | | | minutes | |
| Example 6 | Aqueous | 9.4 | 27 | 20.4 | 120 | OK |
| | ink 6 | | | | degrees | TopKote+ |
| | | | | | Celsius | |
| | | | | | for three | |
| | | | | | minutes | |
| Example 7 | Aqueous | 9.5 | 23 | 19.9 | 120 | OK |
| | ink 7 | | | | degrees | TopKote+ |
| | | | | | Celsius | |
| | | | | | for three | |
| | | | | | minutes | |
| Example 8 | Aqueous | 9.7 | 25 | 20.2 | 120 | OK |
| | ink 8 | | | | degrees | TopKote+ |
| | | | | | for three | |
| | | | | | minutes | |
| Example 9 | Aqueous | 9.7 | 39 | 20.2 | 130 | OK |
| | ink 8 | | | | degrees | TopKote+ |
| | | | | | Celsius | |
| | | | | | for three | |
| | | | | | minutes | |
| Example 10 | Aqueous | 9.6 | 28 | 20.5 | 130 | OK |
| | ink 5 | | | | degrees | Prince |
| | | | | | Celsius | (High |
| | | | | | for three | Grade) |
| | | | | | minutes | |
| Example 11 | Aqueous | 9.4 | 27 | 20.4 | 130 | OK |
| | ink 6 | | | | degrees | Prince |
| | | | | | Celsius | (High |
| | | | | | for three | Grade) |
| | | | | | minutes | |
| Example 12 | Aqueous | 9.5 | 23 | 19.9 | 130 | OK |
| | ink 7 | | | | degrees | Prince |
| | | | | | Celsius | (High |
| | | | | | for three | Grade) |
| | | | | | minutes | |
| Example 13 | Aqueous | 9.7 | 25 | 20.2 | 130 | OK |
| | ink 8 | | | | degrees | Prince |
| | | | | | Celsius | (High |
| | | | | | for three | Grade) |
| | | | | | minutes | |
| Example 14 | Aqueous | 9.7 | 25 | 20.2 | 130 | OK |
| | ink 8 | | | | degrees | Prince |
| | | | | | Celsius | (High |
| | | | | | for three | Grade) |
| | | | | | minutes | |
| Comparative | Aqueous | 9.8 | 45 | 28.5 | 130 | OK |
| Example 1 | ink 9 | | | | degrees | TopKote+ |
| | | | | | Celsius | |
| | | | | | for three | |
| | | | | | minutes | |
| Comparative | Aqueous | 9.4 | 27 | 20.4 | 130 | OK |
| Example 2 | ink 6 | | | | degrees | TopKote+ |
| | | | | | Celsius | |
| | | | | | for three | |
| | | | | | minutes | |
| Comparative | Aqueous | 9.4 | 27 | 20.4 | 130 | OK |
| Example 3 | ink 6 | | | | degrees | TopKote+ |
| | | | | | Celsius | |
| | | | | | for three | |
| | | | | | minutes | |
| Comparative | Aqueous | 9.8 | 45 | 28.5 | 130 | OK |
| Example 4 | ink 9 | | | | degrees | TopKote+ |
| | | | | | Celsius | |
| | | | | | for three | |
| | | | | | minutes | |
| Comparative | Aqueous | 9.8 | 45 | 28.5 | 130 | OK |
| Example 5 | ink 9 | | | | degrees | TopKote+ |
| | | | | | Celsius | |
| | | | | | for three | |
| | | | | | minutes | |

TABLE 6

| | Transfer condition | | | | | |
|---|---|---|---|---|---|---|
| | | | Transfer | | | |
| | Linear | Pressing | temperature | Evaluation for transfer image | | |
| | speed | force | (Degrees | Transfer | Text | |
| | (mm/sec) | (kPa) | Celsius) | density | sharpness | Beading |
| Example 1 | 114 | 350 | 140 | B | B | B |
| Example 2 | 114 | 350 | 140 | A | B | A |
| Example 3 | 114 | 350 | 140 | A | A | A |
| Example 4 | 114 | 350 | 140 | A | A | A |
| Example 5 | 114 | 350 | 140 | A | A | A |
| Example 6 | 114 | 350 | 140 | A | A | A |
| Example 7 | 114 | 350 | 140 | A | A | A |
| Example 8 | 114 | 350 | 140 | A | A | A |
| Example 9 | 114 | 350 | 140 | B | B | A |
| Example 10 | 114 | 350 | 140 | A | A | A |
| Example 11 | 114 | 350 | 140 | A | A | A |
| Example 12 | 114 | 350 | 140 | A | A | A |
| Example 13 | 114 | 350 | 140 | A | A | A |
| Example 14 | 114 | 350 | 90 | B | B | A |
| Comparative | 114 | 350 | 90 | D | D | D |
| Example 1 | | | | | | |
| Comparative | 114 | 350 | 140 | D | D | D |
| Example 2 | | | | | | |
| Comparative | 114 | 350 | 140 | C | C | D |
| Example 3 | | | | | | |
| Comparative | 114 | 350 | 140 | D | D | D |
| Example 4 | | | | | | |
| Comparative | 114 | 350 | 140 | D | D | D |
| Example 5 | | | | | | |

In all of Examples and Comparative Examples, the area of the pretreatment fluid on the intermediate transfer body was made larger than the area of the aqueous ink on the intermediate transfer body.

The aspects of the present disclosure are, for example, as follows:

### Aspect 1

An image forming method includes applying a pretreatment fluid to an intermediate transfer body, applying an aqueous ink to the pretreatment fluid on the intermediate transfer body, drying the pretreatment fluid and the aqueous ink to form an intermediate image, and thermally-transferring the intermediate image to a recording medium, wherein the following conditions (1) to (4) are satisfied:

(1) the intermediate transfer body has a surface with a Shore A Hardness of at most 80;

(2) the surface with a Shore A Hardness of at most 80 and the pretreatment fluid have a contact angle of at most 40 degrees at 1.5 seconds after the pretreatment fluid is applied onto the intermediate transfer body;

(3) the surface with a Shore A Hardness of at most 80 and the aqueous ink have a contact angle of at most 40 degrees at 1.5 seconds after the aqueous ink is applied onto the intermediate transfer body; and

(4) the pretreatment fluid and the aqueous ink have a surface tension of at most 22 mN/m at a bubble life time of 1,500 msec.

### Aspect 2

The image forming method according to Aspect 1 mentioned above, wherein the surface of the intermediate transfer body comprises silicone rubber and fluorine rubber. Aspect 3

The image forming method according to Aspect 1 or 2 mentioned above, wherein the pretreatment fluid contains water, an organic solvent, and at least one of an inorganic acid salt, an organic acid salt, and a cationic polymer.

### Aspect 4

The image forming method according to any one of Aspects 1 to 3 mentioned above, wherein the aqueous ink contains a coloring material, a resin, water, and an organic solvent.

### Aspect 5

The image forming method according to any one of Aspects 1 to 4 mentioned above, wherein the thermally-transferring is conducted at 100 degrees C. or higher.

### Aspect 6

An ink set used in the image forming method of any one of Aspects 1 to 5 mentioned above, the ink set containing the pretreatment fluid and the aqueous ink, wherein the following conditions (1) to (3) are satisfied:

(1) the contact angle between the surface with a Shore A Hardness of at most 80 and the pretreatment fluid is at most 40 degrees at 1.5 seconds after the pretreatment fluid is applied onto the intermediate transfer body;

(2) the contact angle between the surface of the intermediate transfer body having a surface with a Shore A Hardness of at most 80 and the aqueous ink is at most 40 degrees at 1.5 seconds after the aqueous ink is applied onto the intermediate transfer body;

(3) the pretreatment fluid and the aqueous ink have a surface tension of at most 22 mN/m at a bubble life time of 1,500 msec.

### Aspect 7

An image forming apparatus includes an intermediate transfer body, a pretreatment fluid applying device to apply a pretreatment fluid to the intermediate transfer body, an aqueous ink applying device to apply an aqueous ink onto the pretreatment fluid on the intermediate transfer body, a drying device to dry the pretreatment fluid and the aqueous ink to form an intermediate image, and a thermally-transferring device to thermally-transfer the intermediate image to a recording medium, wherein the following conditions (1) to (4) are satisfied:

(1) the intermediate transfer body has a surface with a Shore A Hardness of at most 80;

(2) the surface with a Shore A Hardness of at most 80 and the pretreatment fluid have a contact angle of at most 40 degrees at 1.5 seconds after the pretreatment fluid is applied onto the intermediate transfer body;

(3) the surface with a Shore A Hardness of at most 80 and the aqueous ink have a contact angle of at most 40 degrees at 1.5 seconds after the aqueous ink is applied onto the intermediate transfer body; and

(4) the pretreatment fluid and the aqueous ink have a surface tension of at most 22 mN/m at a bubble life time of 1,500 msec.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

1. An image forming method comprising:
applying a pretreatment fluid to an intermediate transfer body;
applying an aqueous ink to the pretreatment fluid on the intermediate transfer body;
drying the pretreatment fluid and the aqueous ink to form an intermediate image; and
thermally-transferring the intermediate image to a recording medium,
wherein the following conditions (1) to (4) are satisfied:
(1) the intermediate transfer body has a surface with a Shore A Hardness of at most 80;
(2) the surface of the intermediate transfer body and the pretreatment fluid have a contact angle of at most 40 degrees at 1.5 seconds after the pretreatment fluid is applied onto the surface of the intermediate transfer body;
(3) the surface of the intermediate transfer body and the aqueous ink have a contact angle of at most 40 degrees at 1.5 seconds after the aqueous ink is applied onto the surface of the intermediate transfer body; and
(4) the pretreatment fluid and the aqueous ink have a surface tension of at most 22 mN/m at a bubble life time of 1,500 msec.

2. The image forming method according to claim 1, wherein the surface of the intermediate transfer body comprises silicone rubber and fluorine rubber.

3. The image forming method according to claim 1, wherein the pretreatment fluid comprises water, an organic solvent, and at least one of an inorganic acid salt, an organic acid salt, or a cationic polymer.

4. The image forming method according to claim 1, wherein the aqueous ink comprises a coloring material, a resin, water, and an organic solvent.

5. The image forming method according to claim 1, wherein the thermally-transferring is conducted at 100 degrees C. or higher.

6. An image forming apparatus comprising:
an intermediate transfer body;
a pretreatment fluid applying device to apply a pretreatment fluid to the intermediate transfer body;
an aqueous ink applying device to apply an aqueous ink onto the pretreatment fluid on the intermediate transfer body;
a drying device to dry the pretreatment fluid and the aqueous ink to form an intermediate image; and
a thermally-transferring device to thermally-transfer the intermediate image to a recording medium,
wherein the following conditions (1) to (4) are satisfied:
(1) the intermediate transfer body has a surface with a Shore A Hardness of at most 80;
(2) the surface of the intermediate transfer body and the pretreatment fluid have a contact angle of at most 40 degrees at 1.5 seconds after the pretreatment fluid is applied onto the surface of the intermediate transfer body;
(3) the surface of the intermediate transfer body and the aqueous ink have a contact angle of at most 40 degrees at 1.5 seconds after the aqueous ink is applied onto the surface of the intermediate transfer body; and
(4) the pretreatment fluid and the aqueous ink have a surface tension of at most 22 mN/m at a bubble life time of 1,500 msec.
